(19) United States
(12) Patent Application Publication
(10) Pub. No.: US 2026/0186624 A1
(43) Pub. Date: Jul. 2, 2026

(54) SMART BUTTONS FOR AUTOMATION RULES IN COLLABORATION PLATFORMS

(71) Applicant: Atlassian Pty Ltd., Sydney (AU)

(72) Inventors: Alexander Williams, Richmond, VA (US); Kai Chen, Fremont, CA (US); Phuc Le, Milpitas, CA (US); Elaine Hsieh, Los Gatos, CA (US); Dylan Soechting, Austin, TX (US); Dhanraj Jadhav, Union City, CA (US); Avinoam Zelenko, Parkland, FL (US)

(21) Appl. No.: 19/007,092

(22) Filed: Dec. 31, 2024

(51) Int. Cl. G06F 3/0482; G06F 9/54; G06Q 10/101

(52) U.S. Cl. CPC G06F 3/0482; G06F 9/547; G06Q 10/101

(57) ABSTRACT

Methods and systems for smart buttons for automation rules in collaboration platforms are described. The method may include, causing display of a frontend including an editor displaying user-generated content of an electronic document hosted by a first collaboration platform. In response to a text-command input provided to the editor at a particular location within the electronic document, a set of graphical user elements may be displayed in the frontend, each graphical user element corresponding to a respective configurable automation rule template of a set of configurable automation rule templates. A user then selects a graphical user element of the set of graphical user elements, one of which is displayed within the electronic document. When the button element is selected, the automation rule is executed to perform an action of the automation rule on an object of the collaboration system.

### TECHNICAL FIELD

Embodiments described herein relate to multi-tenant services of collaborative work environments and, in particular, to systems and methods for automated user group triggers for collaboration platforms.

### BACKGROUND

An organization can establish a collaborative work environment by self-hosting, or providing its employees with access to, a suite of discrete software platforms or services to facilitate cooperation and completion of work. In many cases, the organization may also define policies outlining best practices for interacting with, and organizing data within, each software platform of the suite of software platforms.

Often internal best practice policies require employees to thoroughly document completion of tasks, assignment of work, decision points, and so on. Such policies additionally often require employees to structure and format documentation in particular ways, to copy data or status information between multiple platforms at specific times, or to perform other rigidly defined, policy-driven, tasks. These requirements are both time and resource consuming for employees, reducing overall team and individual productivity.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified diagram of a system that includes a centralized automation rule service for the creation of automation rules.

FIG. 2 shows an example frontend interface, according to one or more aspects described herein.

FIG. 3 shows an example frontend interface, according to one or more aspects described herein.

FIG. 4 shows an example frontend interface, according to one or more aspects described herein.

FIGS. 5A-5G show example action component editing windows, according to one or more aspects described herein.

FIG. 6 shows an example frontend interface, according to one or more aspects described herein.

FIG. 7 shows an example frontend interface, according to one or more aspects described herein.

FIG. 8 shows an example frontend interface, according to one or more aspects described herein.

FIG. 9 shows an example frontend interface, according to one or more aspects described herein.

FIG. 10 shows an example frontend interface, according to one or more aspects described herein.

FIG. 11 shows an example frontend interface, according to one or more aspects described herein.

FIG. 12 shows an example frontend interface, according to one or more aspects described herein.

FIG. 13 shows an example method for updating or generating content using dynamic automation rule buttons within a collaboration system, according to one or more aspects described herein.

FIG. 14 shows another example method for updating or generating content using dynamic automation rule buttons within a collaboration system, according to one or more aspects described herein.

FIG. 15 shows an example frontend interface, according to one or more aspects described herein.

FIG. 16 shows an example frontend interface, according to one or more aspects described herein.

FIG. 17 shows an example frontend interface, according to one or more aspects described herein.

FIG. 18 shows an example frontend interface, according to one or more aspects described herein.

FIG. 19 shows an example frontend interface, according to one or more aspects described herein.

FIG. 20 shows an example computer-implemented method for collaboration content generation within a collaboration system.

FIG. 21 shows another example computer-implemented method for collaboration content generation within a collaboration system.

FIG. 22 shows a sample electrical block diagram of an electronic device that may perform the operations described herein.

### DETAILED DESCRIPTION

Embodiments described herein relate to systems, devices, and methods for automatically generating rules for collaboration platforms, such as documentation systems, issue tracking systems, project management platforms, and the like.

Collaboration platforms can be used to generate, store, and organize user-generated content. As described herein, a collaboration platform or service may include an editor that is configured to receive user input and generate user-generated content that is saved as a content item. The terms “collaboration platform” or “collaboration service” may be used to refer to a documentation platform, service, or system configured to manage electronic documents or pages created by the system users, an issue tracking platform, service, or system that is configured to manage or track issues or tickets in accordance with an issue or ticket workflow, a source code management platform, service, or system that is configured to manage source code and other aspects of a software product, or a manufacturing resource planning platform, service, or system configured to manage inventory, purchases, sales activity or other aspects of a company or enterprise. The examples provided herein are described with respect to an editor that is integrated with the collaboration platform. In some instances, the functionality described herein may be adapted to multiple platforms or adapted for cross-platform through the use of a common or unitary editor service. For example, the functionality described in each example is provided with respect to a particular collaboration platform, but the same or similar functionality can be extended to other platforms by using the same editor service. Also, as described above a set of host services or platforms may be accessed through a common gateway or using a common authentication scheme, which may allow a user to transition between platforms and access platform-specific content without having to enter user credentials for each platform.

An automation rule (which may also be referred to as “automated rules,” or simply “rules”) is an automated workflow that is generally constructed in a “if this, then that” format. Typically, for example in a collaboration platform, an automation rule results in the performance of an action upon the occurrence of a trigger, if certain conditions are met. In a collaboration platform, each automation rule is made by combining different types of components, including triggers and actions. An automation rule typically also includes a condition. Branches may also be used in some cases. As used herein, automation rules begin with a trigger (which may also be referred to as a trigger component, trigger criteria), the trigger being the catalyst that sets the execution of a rule in motion. In one or more embodiments, a condition (which may also be referred to as a condition component) may also be used, where the condition is a limit on the scope of the automation rule. For example, a condition may require that the rule may only be run when the action that initiated the trigger was performed by a certain user or group of users. As used herein, an action (or action component) is what the rule does or performs, for example what happens when the trigger (and conditions if applicable) is met. In some embodiments, an automation rule may also include a branch. A branch expands the performance or execution of a rule by adding a secondary path (a branch). As used herein, a branch is a sequence of conditions and/or actions that run in isolation from the rest of the rule, but are applied to each (e.g., every) instance of an object. For example, the rule for each task (e.g., an object) can be branched so that a message is sent to a recipient every time a person is mentioned on a particular page (e.g., when such page is published). This branch action occurs in addition to any action on the primary path of the automation rule chain.

In some cases, a collaboration platform may include a large amount of users or content to be managed. Certain tasks may require many repetitive actions, or a person responsible for managing content may not realize that an action needs to be performed to manage the content. As such, a collaboration platform may benefit from allowing users to establish automation rules to automatically perform such tasks that would otherwise need to be performed manually. Such automation rules can reduce management overhead, saving time and freeing up resources, and add management consistency, increasing transparency and organization, while reducing errors.

In some systems, it may be beneficial to provide the ability to execute or run an automation rule based on a manual input from a user. For example, within the context of user-generated content of an electronic document, a user-defined button element (which may also be referred to herein as a “button” or “smart button”), corresponding to an automation rule, may be displayed within a particular location of the user-generated content. Selection of the user-defined button element may then cause execution of the automation rule to perform one or more actions of the automation rule with reference to an object of the collaboration system. The button may be placed within the user-generated content once, or in multiple instances, and may be selected to perform the automation rule from any of the instances. Examples of actions that may be performed as part of the automation rule, response to the user selection of the button include sending an email, changing owner of the electronic document (e.g., page), copying the electronic document, changing a status of the electronic document, adding a label to the electronic document, restricting the electronic document (e.g., by user or space), or publishing the electronic document.

In some examples, a text-command input (e.g., a slash command input) may provided in the editor displaying the user-generated content. In response to an input to a user input to the text-command input, templates corresponding to automation rules may be displayed. The templates may be represented by or otherwise correspond to a set of graphical user elements in the frontend of the first collaboration platform. One or more of the templates may be user-configurable, such that a user may define or otherwise provide values for one or more parameters for an action of the automation rule.

As used herein, templates corresponding to an automation rule include one or more automation rule components that may be executed in accordance with an automation sequence. The templates may be represented, in a GUI, by one or more graphical elements that may be user-selectable in the GUI. In response to a user selection of a template, the automation rule component may be edited by the user. The component may be editable via a graphical element for the template, or one or more windows may be displayed that provide fields or other editable elements that the user may use to provide input to edit, revise, or otherwise modify the automation rule component associated with the template. In some examples, a displayed window may be an example of a component specification window 1004, a first component specification window 1102, and/or a second component specification window 1104, as further described herein. Two or more templates may also be combined to define a new automation rule. As such, one or more templates may be used to define the action(s) to be performed in response to a user selection of a user-defined button element.

In some examples, a rule builder may be used, via a rule builder graphical user interface, to create, configure, and save a user-defined button element as an automation rule. The automation rule may have a trigger component, an action component, and zero or more additional action components, branches, or conditions. The trigger component may be for a user-defined button element, where the selection of the user-defined button element (or “button”) in an electronic document is the trigger (e.g., the selection satisfies the trigger condition) of the automation rule. There may be at least one action component, corresponding to the action to be performed responsive to the trigger having been satisfied via a user selection of the button. A user may specify the action or actions to be performed upon satisfaction of the trigger criteria (e.g., when the button is selected). After the automation rule is generated, the automation rule may be a configurable automation rule that is selectable and configurable by a user from an electronic document of the collaboration platform as a configurable automation rule template. A user may then select the template, for example from a set of templates, to put the button into the electronic document. The button may then be selected to perform the automation rule.

The described user-defined button elements (or smart buttons) can provide increased flexibility and functionality to users of a collaboration system. Such buttons may simplify and streamline certain tasks within electronic document, and can therefore save time, lower expenses, reduce errors, increase engagement with collaboration systems, and otherwise perform administrative and management tasks more effectively and efficiently.

In some automation systems, items such as documents, document hierarchies, tasks, issues, code, boards, or other content items in a collaboration platform or collaboration system must be in existences in order for those items to be subject to an automation rule. This may be due at least in part to an inability of automation rules in such systems to reference non-existent or not-yet-existing items in the component definitions of the automation rule. As further described herein, in some systems, it may be beneficial to provide dynamic references for automation rules, such as the ability for an automation rule to operate on an electronic document generated as part of the same automation rule, content generated by a preceding component of the automation rule, or both. In other cases, such electronic documents may be or include other content items or content item types. Such electronic documents may be referred to herein as an in-process electronic document, and a reference or indicator of such documents may be referred to as an in-process identifier or dynamic reference. The collaboration system may display a graphical user interface of a rule builder of a collaboration platform to a user. In some examples, the collaboration platform may be a documentation platform. A user may select a trigger component for an automation rule via the graphical user interface, and a graphical element representing the trigger component displayed in a proposed automation rule flow. The user may then select a first action component to add to the automation rule, the first action component being configured to generate an in-process electronic document during execution of the automation rule. A graphical element representing the first action component may then be displayed in the proposed automation rule flow. The user may then also select a second action component to add to the automation rule. The second action component may then be configured (e.g., via an action component editing window), and an identifier for the in-process electronic document specified to refer to the first action component. A graphical element representing the second action component may then be displayed in the proposed automation rule flow, along with the graphical user elements for the trigger component and the first action component. The automation rule may then be saved or stored (e.g., at a database for a centralized automation rule service), which may include generating a service on the collaboration system to perform an operation on an object in response to an event that satisfies the trigger component. As specified by the automation rule, the operation uses an in-process identifier for the in-process electronic document associated with the first action component for the second action component.

In one example, electronic documents or other content collaboration items that may be generated by an automation rule may be inputs (dynamic values or dynamic references) within the same automation rule, allowing for more complex structures such as parent and child tree structures in a documentation platform, sub-tasks or sub-issues within an issue tracking platform, or combinations of items. As one example, the automation rule may take as an input a new page of an electronic document, generate a task or issue in an issue tracking system based on the new page, then email an indication of task or issue to a recipient (e.g., the recipient for whom the task was created). As another example, in a documentation system, a user may create an automation rule, and when a new space is generated (e.g., of a particular type of space, or by a certain issue, or labeled with a particular tag), a parent page (the in-process electronic document in this example, indicated by an in-process identifier) is generated in the space, and then a quantity of child pages are generated (e.g., using the in-process identifier) that depend from the parent page.

The described in-process identifiers of in-process electronic documents (e.g., dynamic references) for automation rules can provide increased functionality and improved features for the operation of automation rules, including features not available according to current techniques. The use of in-process identifiers thus may enable increased complexity, and thus utility, of automation rules, further streamlining repetitive tasks, which can save time, lower expenses, reduce errors, and increase engagement with collaboration systems. The use of in-process identifiers in automation rules may also reduce the burden of administrative and management tasks, increasing efficiency.

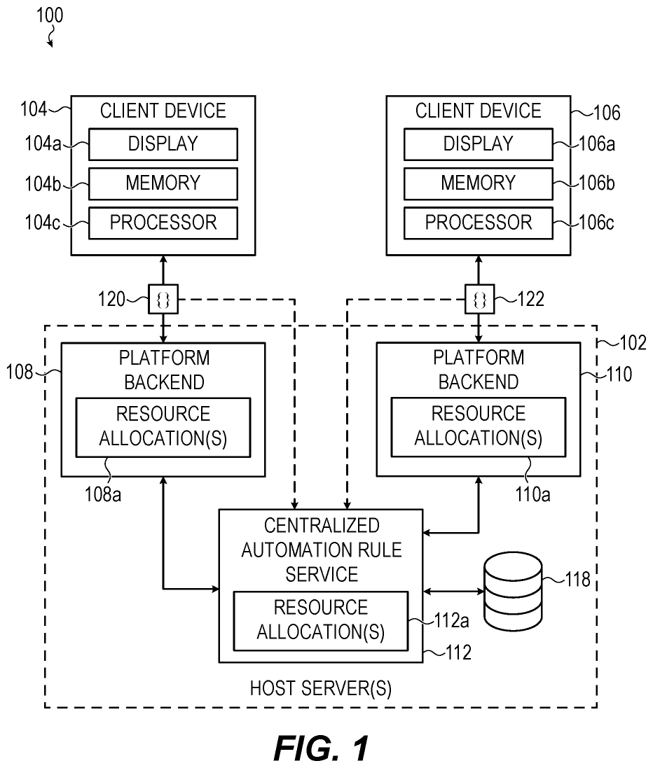

FIG. 1 depicts a simplified diagram of a system 100 that includes a centralized automation rule service for the creation and management of automation rules, as described herein. The system 100 is depicted as implemented in a client-server architecture, but it may be appreciated that this is merely one example and that other communications architectures are possible.

In particular, the system 100 includes a set of host servers 102 which may be one or more virtual or physical computing resources (collectively referred in many cases as a “cloud platform”). In some cases, the set of host servers 102 can be physically collocated or in other cases, each may be positioned in a geographically unique location.

The set of host servers 102 can be communicably coupled to one or more client devices. Two example devices are shown as the client device 104 and the client device 106. The client device 104 and client device 106 can be implemented as any suitable electronic device. In many embodiments, the client device 104 and the client device 106 are personal computing devices such as desktop computers, laptop computers, or mobile phones.

The set of host servers 102 can be supporting infrastructure for one or more backend applications, each of which may be associated with a particular software platform, such as a documentation platform, an issue tracking platform, a source code management platform, and/or a manufacturing resource planning platform. Other examples are information technology system management (ITSM) systems, chat platforms, messaging platforms, and the like. These backends can be communicably coupled to a centralized automation rule service that can be leveraged to provide functionality to each respective backend. For example, the centralized automation rule service can be configured to receive user prompts, such as described herein, to modify, create, or otherwise perform operations to build, validate, debug, or otherwise create and manage automation rules acting on content stored by each respective software platform and triggered by events that may occur at one or more of the software platforms. The centralized automation rule service may provide a single, unified interface to automation rules that operate across different platforms of the host servers 102, providing management and creation capabilities across different platforms of the system.

By centralizing the automation rule service in this manner, the centralized automation rule service can also serve as an integration between multiple platforms. For example, one platform may be a documentation platform and the other platform may be an issue tracking system. In these examples, a user of the documentation platform may create an automation rule that is triggered off of an event that occurs at the documentation platform. An action in response to this event may be performed on one or more objects of the issue tracking system. In some examples, the event may be obtained at or provided to an event monitoring service 130. The event may then be provided to or fetched by the centralized automation rule service 112 as an event message, for example a user identity event message that may fulfil or otherwise satisfy a trigger criteria for one or more automation rules managed or created at the centralized automation rule service 112.

A portion of the set of host servers 102 can be allocated as physical infrastructure supporting a first platform backend 108 and a different portion of the set of host servers 102 can be allocated as physical infrastructure supporting a second platform backend 110.

The two different platforms may be instantiated over physical resources provided by the set of host servers 102. Once instantiated, the first platform backend 108 and the second platform backend 110 can each be communicably coupled with a centralized automation rule service 112 (also referred to as an “automation rule builder” or an “automation rule manager”).

The centralized automation rule service 112 can be configured to cause rendering of a GUI within respective frontends of each of the first platform backend 108 and the second platform backend 110. In this manner, and as a result of this construction, each of the first platform and the second platform present a consistent automation rule creation and management experience for a user.

The centralized automation rule service 112 may include both text input functions as well as selectable graphical elements to select and edit automation rules and components. Selected graphical elements may represent triggers and/or action across different platforms. As a result of the text input or selection of graphical elements, the centralized automation rule service 112 may present graphical elements representing the selected components that make up an automation, for example on the display 104a of a client device 104, or on the display 106a of the client device 106. As a result of this centralized architecture, multiple platforms in a multiplatform environment can leverage the features of the automation rule service. This provides a consistent experience to users while providing cross-platform features for the automation rules.

For example, in one embodiment, a user in a multiplatform environment may use and operate a documentation platform and an issue tracking platform. In this example, both the issue tracking platform and the documentation platform may be associated with a respective frontend and a respective backend. Each platform may be additionally communicably and/or operably coupled to a centralized automation rule service 112 that can be called by each respective frontend whenever it is required to present the user of that respective frontend with an interface to create and manage automation rules.

As described herein, a “content editing frame” references a user interface element that can be leveraged by a user to draft and/or modify rich content including, but not limited to formatted text; image editing; data tabling and charting; file viewing; and so on. These examples are not exhaustive; the content editing elements can include and/or may be implemented to include many features, which may vary from embodiment to embodiment.

As a result of architectures described herein, developers of software platforms that would otherwise dedicate resources to developing, maintaining, and supporting content editing features can dedicate more resources to developing other platform-differentiating features, without needing to allocate resources to development of software components that are already implemented in other platforms.

In addition, as a result of the architectures described herein, services supporting the centralized automation rule service 112 can be extended to include additional features and functionality that, in turn, can automatically be leveraged by any further platform that incorporates an automation rule builder, and/or otherwise integrates with the centralized automation rule service 112 itself.

In addition to the foregoing, a centralized automation rule service 112 as described herein can be configured to suggest discrete commands that can be performed by one or more platforms. As with preceding examples, the ordering of the suggestion list and/or the content of the suggestion list may vary from embodiment to embodiment and user to user. For example, the commands and/or command types presented to the user may vary based on that user's history, the user's role, and so on.

More specifically, the first platform backend 108 can be configured to communicably couple to a first platform frontend instantiated by cooperation of a memory and a processor of the client device 104. Once instantiated, the first platform frontend can be configured to leverage a display of the client device 104 to render a GUI so as to present information to a user of the client device 104 and so as to collect information from a user of the client device 104. Collectively, the processor 104c, memory 104b, and display 104a of the client device 104 are identified as the resources of the client devices, respectively.

As with many embodiments described herein, the first platform frontend can be configured to communicate with the first platform backend 108 and/or the centralized automation rule service 112. Information can be transacted by and between the frontend, the first platform backend 108 and the centralized automation rule service 112 in any suitable manner, form, or format. In many embodiments, as noted above, the client device 104 and in particular the first platform frontend can be configured to send an authentication token 120 along with each request transmitted to any of the first platform backend 108, or the centralized automation rule service 112.

Similarly, the second platform backend 110 can be configured to communicably couple to a second platform frontend instantiated by cooperation of a memory and a processor of the client device 106. Once instantiated, the second platform frontend can be configured to leverage a display of the client device 106 to render a GUI so as to present information to a user of the client device 106 and to collect information from a user of the client device 106. Collectively, the processor 106c, memory 106b, and display 106a of the client device 106 are identified as the client device resources, respectively.

As with many embodiments described herein, the second platform frontend can be configured to communicate with the second platform backend 110 and/or the centralized automation rule service 112. Information can be transacted by and between the frontend, the second platform backend 110 and the centralized automation rule service 112 in any suitable manner, form, or format. In many embodiments, as noted above, the client device 106 and in particular the second platform frontend can be configured to send an authentication token 122 along with each request transmitted to any of the second platform backend 110 or the centralized automation rule service 112.

As a result of these constructions, the centralized automation rule service 112 can provide uniform feature sets to users of either the client device 104 or the client device 106. For example, the centralized automation rule service 112 can implement an automation rule processor to receive an automation rule input provided by a user of the client device 104 to the first platform and/or to receive an automation rule input provided by a different user of the client device 106 to the second platform. Created automation rules may then be accessible to each user via the different ones of client device 104 and client device 106 for management, editing, and so on.

As noted above, the centralized automation rule service 112 ensures that common features are available to frontends of different platforms. In some cases, an API request generated can be directed to another system (not depicted with reference to system 100). For example, the API request can be directed to a third-party service (e.g., referencing a callback, as one example, to either backend platform) or an integration software instance. The integration may facilitate data exchange between the second platform backend 110 and the first platform backend 108 or may be configured for another purpose.

These foregoing embodiments depicted with reference to system 100 and the various alternatives thereof and variations thereto are presented, generally, for purposes of explanation, and to facilitate an understanding of various configurations and constructions of a system, such as described herein. However, some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, many modifications and variations are possible in view of the above teachings.

For example, it may be appreciated that all software instances described above are supported by and instantiated over physical hardware and/or allocations of processing/memory capacity of physical processing and memory hardware. For example, the first platform backend 108 may be instantiated by cooperation of a processor and memory collectively represented in the figure as the resource allocations 108a. Similarly, the second platform backend 110 may be instantiated over the resource allocations 110a (including processors, memory, storage, network communications systems, and so on).

Likewise, the centralized automation rule service 112 is supported by a processor and memory and network connection (and/or database connections) collectively represented for simplicity as the resource allocations 112a.

Further, although many examples are provided above, it may be appreciated that in many embodiments, user permissions and authentication operations are performed at each communication between different systems described above. Phrased in another manner, each request/response transmitted as described above or elsewhere herein may be accompanied by user authentication tokens, user session tokens, API tokens, or other authentication or authorization credentials.

Further to these foregoing embodiments, it may be appreciated that a user can provide input to a frontend of a system in a number of suitable ways, including by providing input as described above to a frame rendered with support of a centralized automation rule service.

As further described herein, the system 100 supports automation rule creation. In one or more embodiments, a GUI is displayed at a client device that includes an input field. In some cases, the client device 104, associated with the first platform backend 108, provides an interface with a first type of software platform, and the client device 106, associated with the second platform backend 110, provides an interface with a different type of software platform. One or both of client device 104 and client device 106 may generate a GUI allowing user input for automation rule generation.

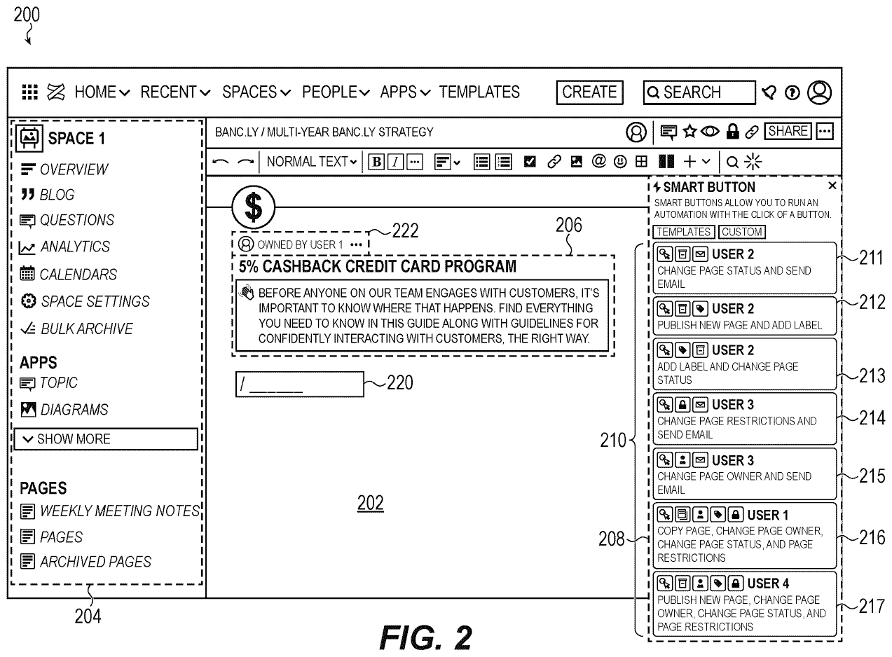

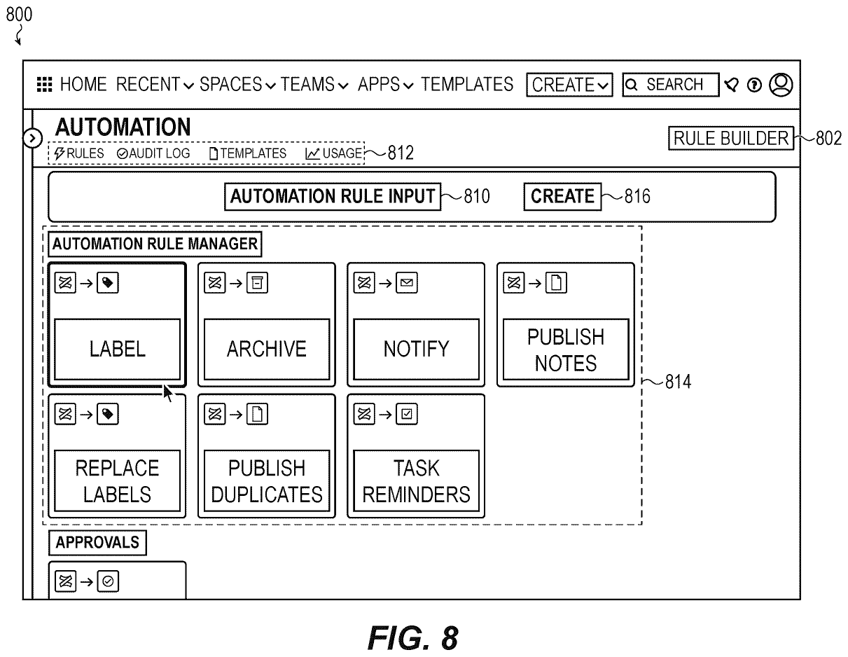

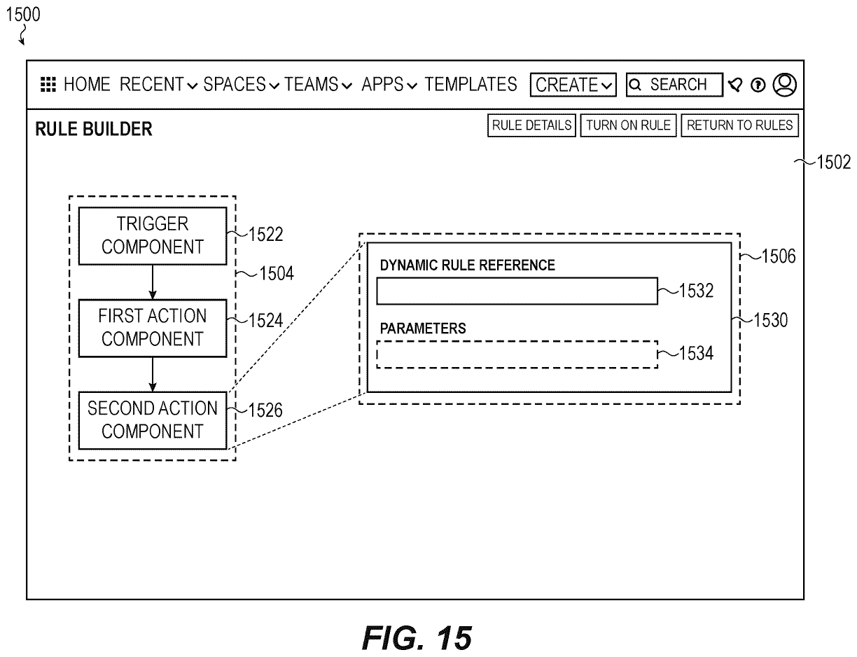

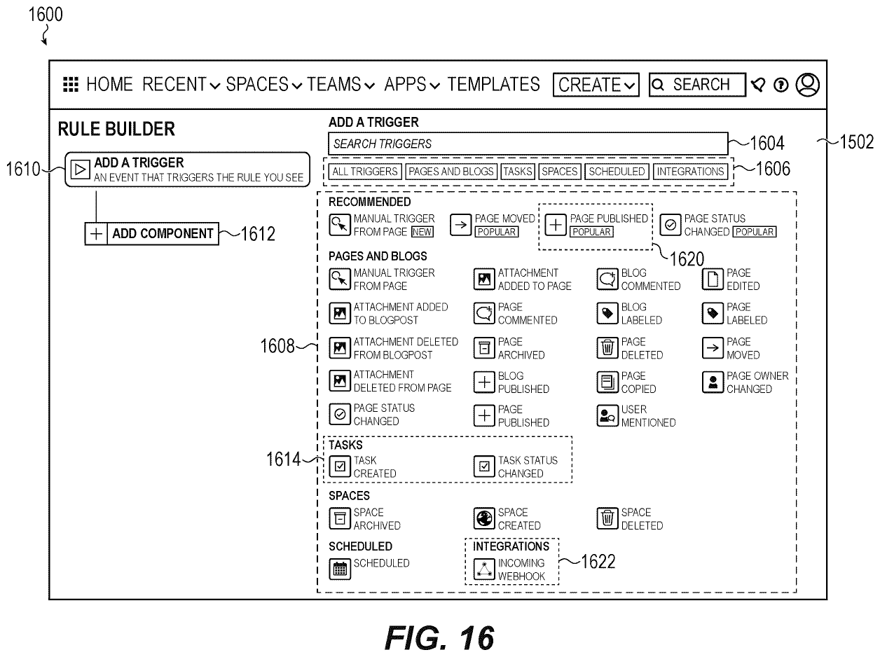

FIGS. 2-14 are generally directed to example features for a user-defined button element (e.g., dynamic automation rule buttons or “smart buttons”). FIGS. 2-7 generally depict frontend interfaces for a user-defined button element in an electronic document. FIGS. 8-11 generally depict interfaces to initiate the creation of an automation rule, the selection of the user-defined button element as a trigger component, and the selection and modification of action components for the user-defined button element. FIG. 12 generally depicts a frontend interface of the management of automation rules, including user-defined button elements. FIGS. 15-19 are generally direct to example features for dynamic references for automation rules. FIG. 15 generally depicts a block diagram of an automation rule that utilizes in-process identifiers for in-process electronic documents (e.g., dynamic references). FIGS. 16-19 generally depict interfaces to initiate the creation of an automation rule, the selection of a trigger component, and the selection and modification of action components that utilize in-process identifiers for in-process electronic documents.

FIG. 2 depicts an example frontend interface 200, according to one or more aspects described herein. Frontend interface 200 may also be referred to as a UI or GUI. In one or more embodiments, frontend interface 200 may be at least a part of a GUI that is rendered by one of first platform backend 108 or second platform backend 110 and displayed at client device 104 or client device 106, respectively. In one or more embodiments, the block diagram of the example frontend interface 200 supports one or more aspects of user-defined button elements for collaboration platforms, as further described herein.

The frontend interface 200 depicts a graphical user interface in an editor or editing view mode. For example, a graphical user interface of frontend interface 200 is a rendering of an electronic document, page, or other electronic content on a client device, such as the client device 104 or 106. The editor is displaying user-generated content of an electronic document hosted by a collaboration platform. The electronic document, page, or other electronic content may be rendered on the client device upon authorization/authentication of a user by an authentication/authorization service, and based on permissions granted to the user according to a user profile associated with the user. In one example, a graphical user interface associated with the frontend interface 200 may have various partitions/sections displaying different content. For example, the frontend interface 200 may include a navigational panel 204, a content panel 202 that may contain user-generated content 206 of an electronic document, and an automation rule template editing panel shown in an editing window 208.

The navigational panel 204 may include a hierarchical element tree, which may also be referred to herein as a page tree. The hierarchical element tree may include an array of hierarchically arranged tree elements. Each tree element of the array of hierarchically arranged tree elements may be positioned and/or displayed with respect to its respective relationship with a current electronic document, page, or electronic content being displayed in the content panel 202. Further each tree element of the array of hierarchically arranged tree elements may be selectable. In other words, in response to a user action or user input with respect to a tree element, an electronic document, page, or electronic content associated with the tree element may be displayed in the content panel 202, or a new instance of a graphical user interface.

Within the navigational panel 204, for example, the selection of a tree element for a page, including weekly meeting notes, pages, or archived pages may display the corresponding user-generated content in the content panel 202. According to the example illustrated for the frontend interface 200, content 206 for the page “5% Cashback Credit Card Program” is displayed as the user generated content within the content panel 202. An indicator 222 of the owner of the content 206 is provided in proximity to the content 206 in the editor. Although not shown, indicators of other information associated with the content 206 may also be displayed within proximity of the content 206, for example a tag.

Within the content panel 202, a text-command input 220 may be provided to the editor, for example at a particular location. As shown, the text-command input 220 may be below the content 206 in the content panel 202. The text-command input 220 (e.g., a slash command input) may be provided to allow a user to access features of the collaboration platform via a shortcut interface. For example, upon entry of a “/” character in the editor followed by text to indicate a command that is being invoked, the collaboration platform may open a menu in the frontend interface 200 that includes selectable graphical elements, which may include for example tools from a toolbar like paragraph formatting and lists as well as adding links, images, mentions, emojis, tables, and layouts; elements like expands, dates, adding files, quotes, code snippets, and statuses; macros; or custom applications. In some examples, the text-command input 220 may operate in an autocomplete menu, where entry of a character or two may cause the collaboration platform to display potential shortcuts whose name, description, or other identifier begins with those one or two characters. Entry of additional characters may serve to further narrow the potential shortcuts (e.g., as fewer matching shortcuts are available as matches). Once a user identifies a matching shortcut that is displayed in response to the entered character, the user may select the displayed shortcut to trigger, initiate, or otherwise cause an action of the shortcut to be performed. In the example depicted with reference to the frontend interface 200, the text-command input 220 has been used to cause display of a set of graphical user elements corresponding to a set of configurable automation rule templates 210.

The set of configurable automation rule templates 210 may be displayed in the frontend interface 200 in an editing window 208. The editing window may be hidden or otherwise not displayed in the frontend interface 200 prior to receiving the text-command input 220. In response to text-command input 220 at a particular location within the electronic document, the editing window 208 for a user-defined button element (which may also be referred to as a “smart button”) may be displayed. The editing window 208 may contain one or more configurable automation rule templates. In an example, the set of configurable automation rule templates 210 includes seven configurable automation rule templates 211 through 217. Each of the configurable automation rule templates 211 through 217 may be selectable by a user to configure and create a user-defined button element. The location of the user-defined button element may be at a location determined with reference to the text-command input 220, for example replacing the text-command input 220 in the content panel 202.

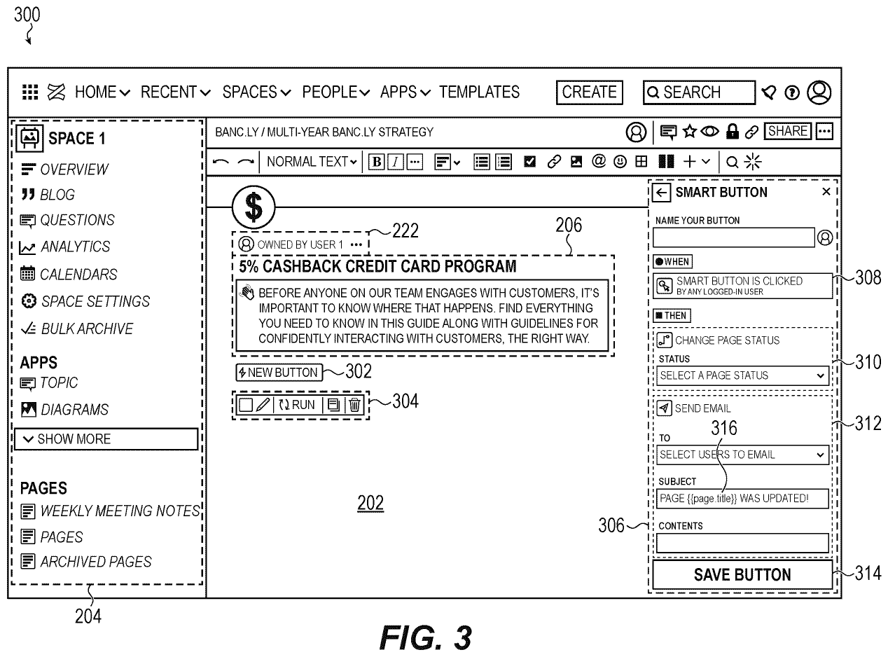

FIG. 3 depicts an example frontend interface 300 that supports smart buttons for automation rules in collaboration platforms, according to one or more aspects described herein. Frontend interface 300 may also be referred to as a UI or GUI. In one or more embodiments, frontend interface 300 may be at least a part of a GUI that is rendered by one of first platform backend 108 or second platform backend 110 and displayed at client device 104 or client device 106, respectively. In one or more embodiments, frontend interface 300 may be rendered and displayed in response to a user providing a text-command input that selects one of the configurable automation rule templates of the set of configurable automation rule templates 210.

The user-defined button element 302 (e.g., a button) may be displayed in the content panel 202 in response to a selection of a graphical user element corresponding to the configurable automation rule template 211, which is labeled as “change page status and send email.” An editing window 306 may also be displayed (e.g., caused to be displayed) in the content panel 202 responsive to a selection of the configurable automation rule template 211 and/or responsive to a selection of the user-defined button element 302. The editing window 306 may allow a user to provide or modify one or more parameters of the user-defined button element.

In some examples, a user-defined button element 302 may result from the selection of one configurable automation rule template (e.g., configurable automation rule template 211) of the set of configurable automation rule templates 210. In other examples, a user-defined button element 302 may be a result of the selection of two or more configurable automation rule templates of the set of configurable automation rule templates 210 (e.g., configurable automation rule templates 212 (“publish new page and add label”) and configurable automation rule templates 213 (“add label and change page status”)).

A trigger editing window 308 may be displayed in the editing window 306 for a user-defined button element. The trigger editing window 308 may be used to set or modify criteria for a trigger component of an automation rule, which in the example depicted with reference to the frontend interface 300, may be the user-defined button element (e.g., “smart button”). In some examples, the trigger component may have one or more associated conditions (e.g., “by any logged-in user”), such the user-defined button element 302 may be selected by any logged-in user.

In other examples, an input field for the trigger editing window 308 may allow for the specification of a category or class of users that may initiate the performance of the automation rule responsive to selecting the user-defined button element. Examples of a category or class of users may be those users having permission to edit the current electronic document (e.g., the electronic document having the user-defined button element), administrators of the collaboration platform, or available to anyone having access to the electronic content.

The user-defined button element 302 may be associated with a first action component and a second action component for the user-defined button element 302. A first editing window 310 for the first action component and a second editing window 320 for the second action component may be displayed in the editing window 306. For an automation rule, the first action component and the second action component may define what occurs when the trigger criteria of the automation rule is satisfied, that is, when the user-defined button element 302 is selected in the content panel 202. Although two action components are depicted, one action component may also be used, or three or more action components in other examples.

The first editing window 310 may be generally directed to changing the status of a page (e.g., of the electronic document associated with the user-generated content 206 of the content panel 202). As such, an input field may be provided to allow for a user selection of a page status to be set as a result of a user selection of the user-defined button element 302. Examples of a page status may be draft, rough draft, in progress, or ready for review.

The second editing window 312 may be generally directed to sending an email to one or more recipients. As such, a recipient input field may be provided to allow for a user selection of one or more users to send an email (e.g., or other message such as a text message, message of the collaboration platform, or other communication form) as a result of a user selection of the user-defined button element 302. In some examples, the recipient input field may be a drop-down list of available recipients, for examples users of the collaboration platform. In other examples, the recipient input field may act as an auto-fill, where a user may input one, two, or more characters, and recipients whose first one, two, or more characters match those characters are displayed for potential selection by a user. A subject input field may be available for a user to provide text input that will be in the subject line of the email that is transmitted in response to a user selection of the user-defined button element 302. A content input field may be available for a user to provide text input that will be the contents of the email. in the subject line of the email that is transmitted in response to a user selection of the user-defined button element 302.

In some examples, a reference value (which may also be referred to as a “smart value”) may be used for an action component of the automation rule. For example, reference value 316 may be used when running the automation rule to popular the subject field, or a portion of the subject field, with a page title from the content 206 (e.g., {{page.title}}). In other examples, different reference value types may be used, such as in the contents (e.g., text, links, images, or other content types) or in the recipients (e.g., the owner of the content 206).

The save button 314 may be a graphical user element that causes generation of the automation rule defined via the editing window 306 for the user-defined button element 302. The editing window 306 may be displayed and/or hidden in response to detecting a user interaction with the user-defined button element, user-defined button element 302. In response to detecting the user interaction, an editing toolbar 304 may be displayed within the electronic document (e.g., within the content panel 202), the editing toolbar 304 providing selectable elements to edit the user-defined button element 302, run the automation rule associated with the user-defined button element 302, view the components underlying the editing toolbar 304, or delete the user-defined button element 302.

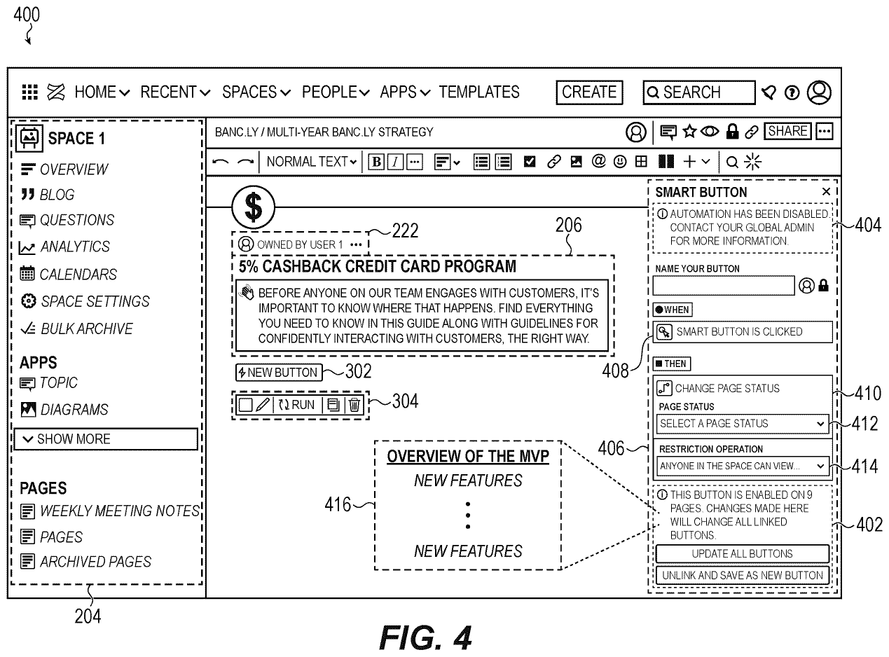

FIG. 4 depicts an example frontend interface 400 that supports smart buttons for automation rules in collaboration platforms, in accordance with aspects described herein. Frontend interface 400 may be an example of the frontend interface 300 where different action components are used in connection with the user-defined button element 302.

The frontend interface 400 may display an editing window 406 for the user-defined button element 302. In the example of the frontend interface 400, the automation rule associate with user-defined button element (e.g., user-defined button element 302) includes a trigger of when the user-defined button element 302 is selected (e.g., click by a cursor controlled by a user) and an action of changing a page status in response. The trigger editing window 308 may be used to create, update, review, or otherwise modify a trigger component of the automation rule.

A first editing window 410 of the editing window 406 may be generally directed to changing the status and restriction operation for a page (e.g., of the electronic document associated with the user-generated content 206 of the content panel 202). As such, a first input field 412 may be provided to allow for a user selection of a page status to be set as a result of a user selection of the user-defined button element 302. Examples of a page status may be draft, rough draft, in progress, or ready for review. A second input field 414 may be provided to allow for a user selection of a restriction operation or level for the page. Examples of the restriction operation or level me be that any user or group in the same space as the page may view the page, any user or group in the same space as the page may both view and edit the page, any user or group can view page, or any user or group can both view and edit the page.

In the example shown for the frontend interface 400, a message 402 may be displayed as a warning to a user modifying or attempting to modify the automation rule for the user-defined button element 302. For example, the message 402 may indicate that the user-defined button element 302 may be enabled (e.g., available for a user to select) on nine pages, and that changes made in the frontend interface 400 will change all the linked buttons. Included with the message 402 may be a first graphical element that allows a user to select to update all the buttons that are the subject of the message 402. A second graphical element may allow the user to unlink the current user-defined button element 302 from the other instances of the button (e.g., the other linked buttons) and save the current user-defined button element 302 as a new button.

In some examples, a notification window 416 may be displayed responsive to a user selecting the graphical element displaying the message 402. In other examples, the notification window 416 may be displayed responsive to a user hovering over (e.g., with a cursor) the message 402. The notification window 416 may display a list or other indicators of the other nine pages (or other collaboration content items) where the user-defined button element 302 is enabled.

In some examples, a notification window 404 may also be displayed responsive to the collaboration platform determining to disable the automation rule associated with the user-defined button element 302. In some examples, the automation rule may be disabled responsive to the button being present across a quantity of pages, and the warning of the notification window 416 for the user-defined button element 302 not having yet been resolved.

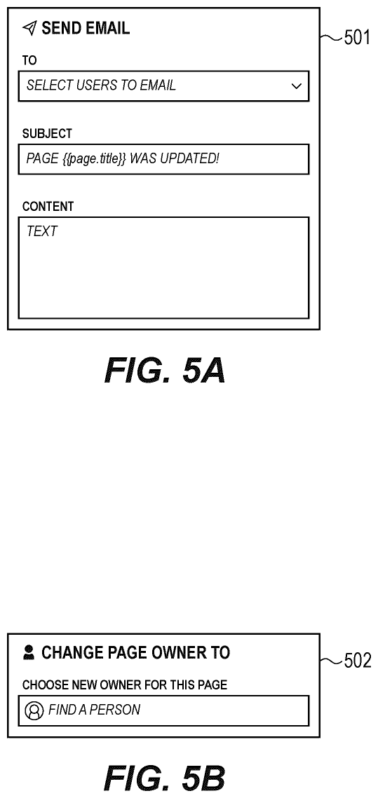

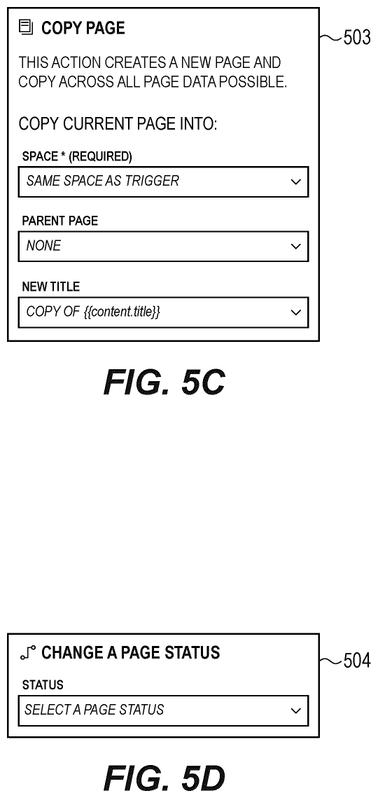

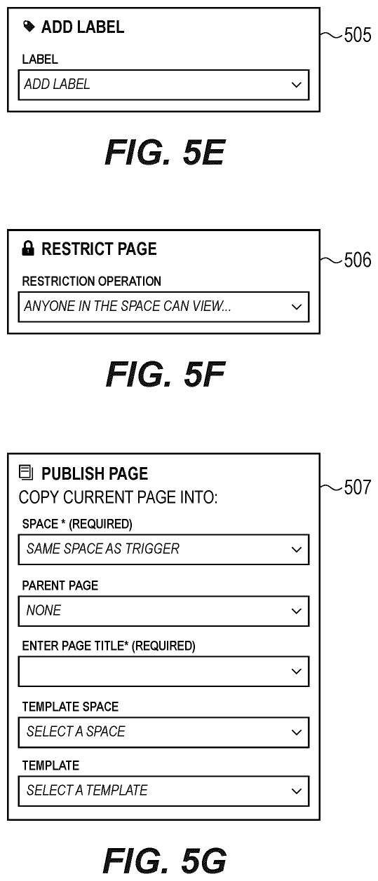

FIGS. 5A-5G depict example editing windows 501 through 507 that may be used in a frontend interface in connection with user-defined button elements. For example, editing windows 501 through 507 may be examples of editing windows for an action component of an automation rule associated with user-defined button elements discussed with reference to the frontend interface 200, the frontend interface 300, or the frontend interface 400. One or more action components corresponding to the editing windows 501 through 507 may be used in connection with a single automation rule for a user-defined button element. In some examples, multiple different instances of a same action component (e.g., but configured differently) may be used for the automation rule. For example, a first copy page action (e.g., corresponding to example editing window 503) may be configured with a first space value, while a second copy page action (e.g., corresponding to example editing window 503) may be configured with a second space value. In some examples, an editing window of editing windows 501 through 507 may correspond to an action component of an automation rule. The editing window may be displayed in connection with any one or more of the frontend interfaces 200, 300, 400, 600, or 700, or displayed in connection with editing an action component within an automation rule builder in connection with any one or more of the frontend interfaces 800 through 1300.

FIG. 5A depicts an example editing window 501 for a send email action. The editing window 501 includes a first input field (“TO”) to specify one or more recipients for an email, a second input field (“SUBJECT”) to specify the text of the subject field of the email, and a third input field (“CONTENT”) to provide text for the body of an email. One or more reference values may be used in any of the first input field, the second input field, or the third input field. For example. {{page.title}} may be used as a reference to populate, in the email subject line, the title of the page from which the email was triggered as an automation rule. In other examples, different reference value types may be used, such as references in the contents (e.g., to text, links, images, or other content types of the electronic document from which the automation rule was triggered) or in the recipients (e.g., the owner of the electronic document, or content thereof).

FIG. 5A depicts an example editing window 501 for a send email action. The editing window 501 includes a first input field (“TO”) to specify one or more recipients for an email, a second input field (“SUBJECT”) to specify the text of the subject field of the email, and a third input field (“CONTENT”) to provide text for the body of an email. One or more reference values may be used in any of the first input field, the second input field, or the third input field. For example. {{page.title}} may be used as a reference to populate, in the email subject line, the title of the page from which the email was triggered as an automation rule using a user-defined button element.

FIG. 5B depicts an example editing window 502 for a change page owner action. The editing window 502 includes an input field to specify a new owner for the page or other collaboration content item (e.g., electronic document) from which the automation was triggered using a user-defined button element.

FIG. 5C depicts an example editing window 503 for a copy page action. The editing window 503 includes a first input field (“SPACE”) to specify a space to which the page is to be copied. The page may be copied to a same space as the page from which the automation rule was triggered. In some examples, the page may be copied as a child page to an existing parent page, in which case the parent page may be specified in a second input field (“PARENT PAGE”). A third input field (“NEW TITLE”) may be used to provide a name for the new page. One or more reference values (e.g., {{content.title}}, {{page.title}}) may be used for example to give the new, copied page the same name as the page from which the automation rule was triggered.

FIG. 5D depicts an example editing window 504 for a change page status action. The editing window 504 includes an input field to specify a new page status for the page or other collaboration content item (e.g., electronic document) from which the automation was triggered using a user-defined button element. In some examples, a page status may be draft, rough draft, in progress, or ready for review, and may be selected from a drop-down. In other examples, a first portion of an input may be provided and partially matching values may be returned to a user for selection. In yet other examples, the user may be able generate new page statuses with a text input.

FIG. 5E depicts an example editing window 505 for an add label action. The editing window 505 includes an input field to specify a label to add to the page or other collaboration content item (e.g., electronic document) from which the automation was triggered using a user-defined button element. In some examples, the label may be selected from a drop-down menu of previously-configured labels (e.g., provided by an administrator or other user of the collaboration platform). In other examples, a first portion of a label may be provided and partially matching values may be returned to a user for selection, or to be overwritten by a user with a new label value. In yet other examples, the user may be able to enter the label value (e.g., new, or existing) with a text input. In some examples, the editing window 505 may allow for the creation of two or more labels as part of a same action component for the automation rule. In other examples, multiple action components may be used for an automation rule to achieve adding respective multiple labels in response to a selection of a user-defined button element.

FIG. 5F depicts an example editing window 506 for a restrict page action. The editing window 506 includes an input field to specify a restriction operation for the page or other collaboration content item (e.g., electronic document) from which the automation was triggered using a user-defined button element. Examples of the restriction operation or level me be that any user or group in the same space as the page may view the page, any user or group in the same space as the page may both view and edit the page, any user or group can view page, or any user or group can both view and edit the page. In other examples, a first portion of an input may be provided and partially matching values may be returned to a user for selection. yet other examples, the user may be able generate new page statuses with a text input.

FIG. 5G depicts an example editing window 507 for a publish page action. The editing window 507 includes a first input field (“SPACE”) to specify a space to which the page is to be published. The page may be published to a same space as the page from which the automation rule was triggered. In some examples, the page may be published as a child page to an existing parent page, in which case the parent page may be specified in a second input field (“PARENT PAGE”). A third input field (“ENTER PAGE TITLE”) may be used to provide a name for the page to be published. One or more reference values (e.g., {{content.title}}, {{page.title}}) may be used for example to give the published page the same name as the page from which the automation rule was triggered, or use the name of the page at least partially in a new (e.g., longer) title for the published page. A fourth input field (“TEMPLATE SPACE”) may be used to provide a user selection of space for publication of the page that triggered the automation rule. The user selection may be from a list of spaces displayed in a drop-down menu. A fifth input field (“TEMPLATE”) may be used to provide a user selection of a template to be used for the publication, where the set of available templates may be specific to the space, for example the space specified via the fourth input field.

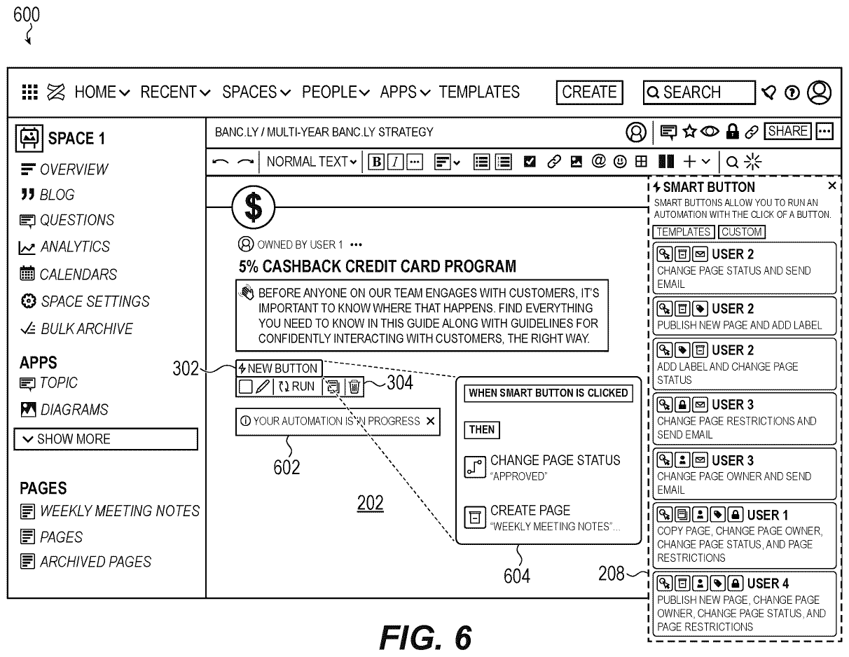

FIG. 6 depicts another example frontend interface 600 that supports smart buttons for automation rules in collaboration platforms, in accordance with aspects described herein. Frontend interface 600 may be an example of the frontend interface 300 or frontend interface 400, where an information window 602 and/or a status notification 604 are displayed.

In some examples, in response to detecting a user interaction with the user-defined button element 302, an information window 602 may be displayed within the electronic document. The information window 602 may display an indication of actions of an automation rule to be performed responsive to the user selection of the user-defined button element 302. The actions of the automation rule may include one or more actions. In the example of frontend interface 600, two actions are illustrated, including a change page status action (to an “approved” status) and a create page action (having a page title of “weekly meeting notes”).

In some examples, in response to the user selection of the user-defined button element 302, a status notification 604 regarding the performance of an action of the automation rule associated with the user-defined button element 302 may be displayed. The status notification 604 may provide an update regarding the performance and operation of the automation rule that was triggered by a user selection of the user-defined button element 302. Such a status notification 604 may indicate to a user of the collaboration platform and viewing the frontend interface 600 whether the operation of the automation rule has been successfully performed. In some examples, the status notification 604 may include text communicating a state of the automation rule performance. For example, the status notification 604 may indicate the successful completion of the performance of the automation rule, that the automation rule performance is in progress (e.g., “your automation is in progress”), or that the performance of the automation rule has failed or otherwise had errors.

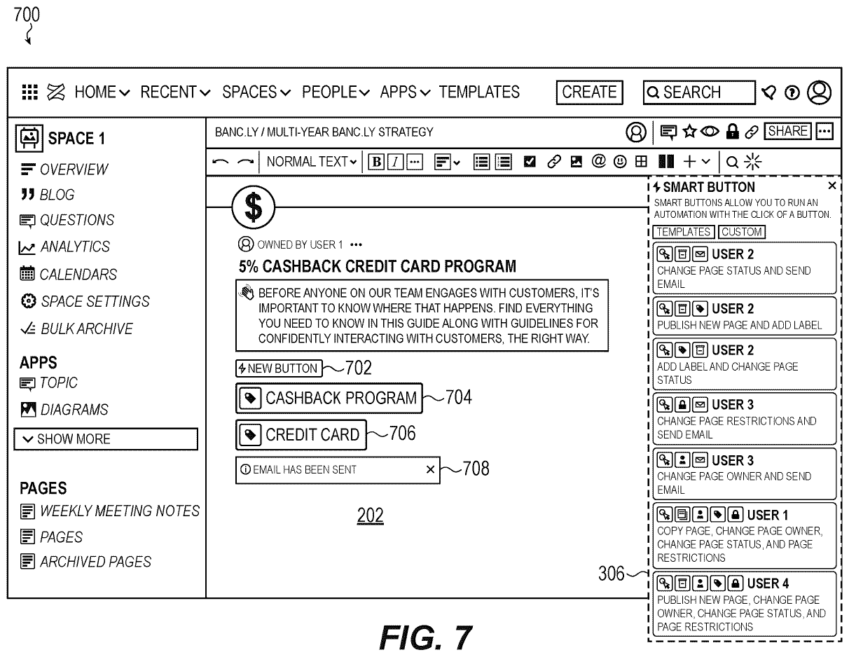

FIG. 7 depicts another example frontend interface 700 that supports smart buttons for automation rules in collaboration platforms, in accordance with aspects described herein. Frontend interface 700 may be an example of the frontend interface 300, frontend interface 400, or frontend interface 600, following the successful performance of an automation rule.

In response to a user selection of the user-defined button element (e.g., button 702), an automation rule may be run. As previously described, the automation rule may be configured to operate according to a configurable automation rule template, for example selected from a set of configurable automation rule templates and configured to perform one or more actions, including at least adding a first label 704 and a second label 706. The action component of the automation rule may determine that the trigger criteria have been met and attach a label to the electronic document that was the source of the trigger (e.g., the selection of the button 702) according to a first action component to attach the first label 704, and a second action component to attach the second label 706. The action component of the automation rule may determine that the trigger criteria have been met and attach a label to the electronic document that was the source of the trigger (e.g., the selection of the button 702).

The automation rule may further include an action component to send an email according to one or more parameters. Upon completion of sending the email, a status notification 708 may be displayed. In some examples, the status notification 708 may indicate the successful completion of the performance of the automation rule (e.g., “email has been sent”). In other scenarios or examples, the automation rule performance is in progress, via the status notification, and/or that the performance of the automation rule has failed or otherwise had errors.

A user-defined button element (e.g., a button 702) may be moved within content of a content item (e.g., of an electronic documents, task, issue, and so on), for example like or similar to the movement of other user-generated items within the content item. The button 702 may be inserted and placed in-line with user-generated text, or placed above, below, or adjacent to user-generated content of the content item. A button 702 may also be duplicated within a content item (e.g., such that multiple instances of the same button 702 are present within a content item). In some examples, each instance of a button 702 may provide a same functionality (e.g., perform a same action) as other instances of the button 702. In other examples, different instances of the button 702 may provide different functionality (e.g., perform a different action, or perform a same action component configured differently) as one or more other instances of the button 702. A button 702 may also be duplicated across different content items. In some examples, a same automation rule may be referenced by each instance of the button 702 from the different content items.

FIG. 8 depicts an example frontend interface 800 that supports user-defined button elements for collaboration platforms, in accordance with aspects described herein. The frontend interface 800 can be rendered by a client device 104 or a client device 106. The client device can include a display with an active display area in which a user interface, e.g., frontend interface 200 can be rendered. The user interface can be rendered by operation of an instance of a frontend application associated with a backend application that collectively defines a software platform as described herein.

As shown, frontend interface 800 includes rule builder button 802, a text input field 810, selectable tabs 812, a display area 814, and a create button 816. Text input field 810 is a field configured to accept textual inputs, for example a natural language rule for the creation of automation rules. The create button 816 can be used to submit the textual input in the text input field 810 for creation of an automation rule by the system 100.

In one or more embodiments, selectable tabs 812 include tabs for “rules,” “an audit log,” “templates,” and “usage,” each of which may cause a different display to appear in display area 814. Selecting the rules field causes the display area 814 to display automation rules for management. The information for the displayed rule can include at least a name, description scope (e.g., on what projects, or types of projects, the rule will run), an indication of whether to allow the rule to run from another rule, an error notification status, an owner of the rule, a rule actor (e.g., the party indicated as responsible when the rule is executed), and permissions for the rule (e.g., persons or groups allowed to modify the rule). As an example of automation rules, an automation rule manager may display a list, icon, or other indicator of automation rules created by a user in display area 814. Examples of such automation rules (e.g., created or for a template, as further discussed herein) include a “label” rule (e.g., adding a specific label when a page is published by a certain author), an “archive” rule (e.g., archiving inactive pages when scheduled (recurring)), a “notify” rule (e.g., notify certain people about inactive pages when scheduled (recurring)), a “publish notes” rule (e.g., publish new meeting notes page when scheduled (recurring)), a “replace labels” rule (e.g., replace a label on all pages when scheduled (recurring)), a “publish duplicates” rule (e.g., publish the same set of pages when a new space is created), and a “task reminders” rule (e.g., remind teammates about incomplete tasks when scheduled (recurring)). In some embodiments, these example rules may support automation rules within a documentation platform. In other embodiments such rules, or other rules, can be for other platforms or a combination of platforms within a system including collaboration platforms.

In one or more embodiments, selecting the templates tab may cause a display to appear in display area 814 that includes templates that a user may utilize to create automation rules from a template. Such templates provide predefined structure for common automation rules that a user may want to use in the manual creation of an automation rule.

In one or more embodiments, selecting the audit log tab may cause a display to appear in display area 814 that includes an audit log for the automation rules. In one or more embodiments, each automation rule may include an audit log that identifies when the automation rule was triggered, the final result of the execution of the automation rule, and any action performed as a result of the automation rule execution. In some embodiments, the audit log may indicate a duration of the execution and the status (e.g., success, error, and so on) of the execution.

In one or more embodiments, selecting the usage tab may cause a display to appear in display area 814 that includes usage information for the automation rules. The usage information includes an outline of your automation usage (e.g., for a particular time frame). For example, each automation rule may be identified, together with a quantity of runs/executions of the automation rule, an “owner” or other responsible person for the rule, a scope of the rule (e.g., which collaboration systems are associated with the rule), and an activation status for the automation rule (e.g., whether execution of the rule is turned “on” or “off”).

According to one or more embodiments, previously-created automation rules, including automation rules generated from using a generative output engine, as further described herein, can be stored at the system 100. In some examples, rules may be stored in a database 118 for retrieval and use by a component of the set of host servers 102, such as the centralized automation rule service 112, the first platform backend 108, or the second platform backend 110. In some examples, the rules may be stored in the resource allocation of a portion of the host servers 102, such as the resource allocation of the platform from which the automation rule is to be executed, for example resource allocations 108a of the first platform backend 108, or resource allocations 110a of the second platform backend 110.

In one or more embodiments, the rule builder button 802 may be selected by a user to direct the frontend interface 800 to a rule builder that can be leveraged by a user to generate automation rules from components with assistance from graphical elements, as further described herein.

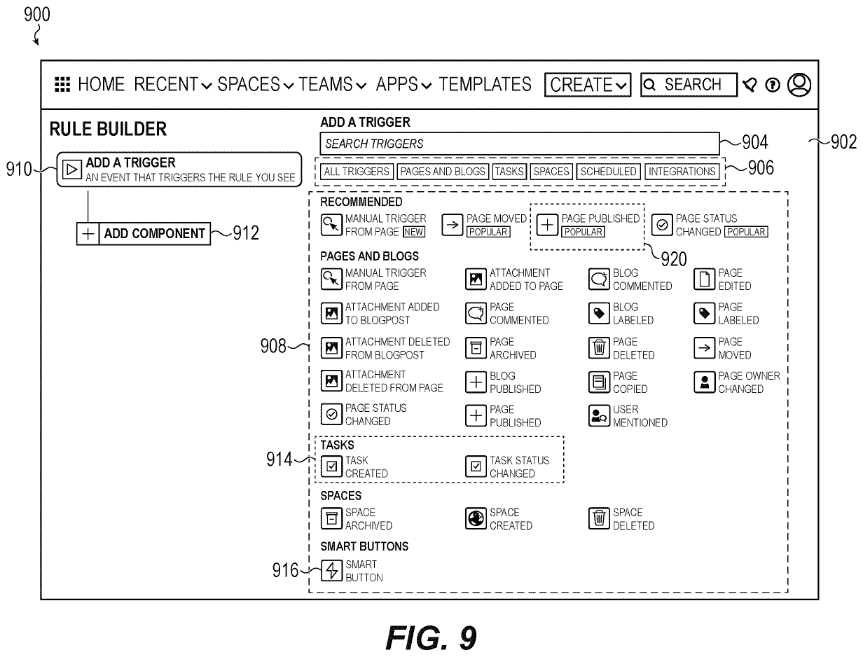

FIG. 9 shows an example frontend interface 900 that supports user-defined button elements for collaboration platforms, in accordance with aspects described herein. Frontend interface 900 may also be referred to as a UI or GUI. In one or more embodiments, frontend interface 900 may be displayed at a same display or interface as one or more of the frontend interfaces described herein. The frontend interface 900 displays the rule builder 902, which includes graphical elements to assist a user in generating an automation rule to operate in a collaboration system (e.g., system 100), as further described herein. In some embodiments, rule builder 902 may be at least a part of a GUI that is rendered by one of first platform backend 108 or second platform backend 110.

Generally, the proposed automation flow region includes graphical elements representing automation rule components. In some examples, the graphical elements representing automation rule components may be replaced during rule building with graphical elements representing selected automation rule components. For example, the proposed automation flow region may include a trigger adding button 910 that may be replaced by a graphical element representing a selected trigger component, and a component adding button 912 that may be replaced by a selected action component. The proposed automation flow region may expand or contract as automation rule components (and their respective graphical elements) are added or deleted.

Generally, the control region may include a search box for automation rule components, tabs for categories of those automation rule components, and graphical elements representing selectable automation rule components.

In one or more embodiments, the rule builder 902 of the frontend interface 900 may include a search box 904, a set of tabs 906, and a set of trigger components 908 in the control region, and a trigger adding button 910 and a component adding button 912 in the automation workflow region. Frontend interface 900 illustrates a simplified view. In some embodiments, rule builder 902 may be embedded within another GUI (e.g., window), or include one or more additional textual and/or graphical elements not shown with reference to frontend interface 900.

The search box 904, the set of tabs 906, and the set of trigger components 908 may be rendered and displayed to a user, for example responsive to the user initiating (starting, entering) the rule builder 902 and selecting the graphical element that is the trigger adding button 910. In some embodiments, after selecting a trigger component for an automation rule, a user may select the graphical element that is the add a component, button 912. In other embodiments, a user may select the graphical element that is the add a button 912 before selecting the trigger component.

The set of trigger components 908 includes trigger components that may be used to initiate an automation rule based on an event. In some embodiments, the triggers may be organized into one or more groups or subsets of triggers components. In the example of the frontend interface 900, the groups include recommended, pages and blogs, tasks, spaces, scheduled, and integrations. In this example, the recommended triggers include a manual trigger from a page, a page moved, a page published, or a page status changed, for example page published trigger 920. The pages and blogs triggers include a manual trigger from a page, at attachment added to a blogpost, an attachment added to a page, at attachment deleted from a blogpost, an attachment deleted from a page, a blog commented, a blog labeled, a blog published, a page archived, a page comments, a page copied, a page deleted, a page edited, a page labeled, a page moved, a page owner changed, a page published, a page status changed, or a user mentioned. The task triggers include task created and task status changed. The spaces triggers include space archived, space created, or space deleted. Other triggers of the set of triggers may include a scheduled trigger or an incoming webhook trigger. The smart button trigger 916, which may also be referred to as a trigger for a user-defined button element or user-defined button element trigger, may be selected and configured by selecting the smart button trigger 916 within the frontend interface 900.

In one or more embodiments, the recommended triggers of the set of trigger components 408 may be based on a usage history for the user, such as the quantity of uses for the trigger component exceeding a threshold value or the user's most used trigger components (e.g., ten most used trigger components). In other embodiments, the recommended triggers are based on the quantity of uses by a group of users (e.g., of the platform, or accessing a centralized automation rule service 112), and may include the most used trigger components or the trigger components whose usage has exceeded a threshold value. In some cases, the recommended triggers may be a curated list within a platform or the centralized automation rule service 112, and may depend on which platform a user is accessing. In some embodiments, a generative output service may be trained on the usage of trigger components for automation rules within a platform or set of platforms, and be used to determine the recommended trigger components based on one or more inputs and a list of potential or candidate trigger components. In some examples, the generative output service can receive (e.g., from the centralized automation rule service 112) information regarding a history of trigger component selections (e.g., for a particular user, group of users, particular platform, or by other groupings), and this information used by the generative output service to provide (e.g., from the centralized automation rule service 112) an indication (e.g., suggestion or recommendation) for a trigger component or set of trigger components 908 (e.g., as the “recommended” trigger components) as part of automation rule building and creation.

The trigger groups for the set of trigger components 908 may be selectable via the set of tabs 906. For example, by selecting the “tasks” selectable element, the set of trigger components 908 may be pared down to display only the associated task triggers 914 (e.g., task created and task status changed), and the other available trigger components hidden.

Search box 904 accepts textual inputs from a user, and in response, the rule builder 902 can filter the set of trigger components 908. In some embodiments, the displayed set of trigger components 908 may be pared down such that only trigger components that satisfy the search are displayed (and other, non-responsive trigger components hidden). In other embodiments, a drop-down or pop-up may be displayed that includes selectable trigger components that satisfy the search.

In some embodiments, trigger components may include one or more of a field value changed, form submitted, incoming webhook, issue assigned, issue commented, issue comment edited, issue created, issue deleted, issue linked, issue link deleted, issue moved, issue transitioned, issue updated, a manual trigger from an issue, a combination of issues, when work is logged, a sprint is created, started, or completed, a version is created, updated, or released, a branch created, build failed, build status changed, build successful, commit created, deployment failed, deployment status changed, deployment successful, pull request create, pull request, declined, pull request merged, vulnerability found, object triggered, service limit breach, a service legal agreement threshold breached, approval required, approval completed, or an emoji reaction to application message. In some embodiments, these example triggers are intended for use with reference to the context of an issue tracking platform.

Additionally, or alternatively, trigger components may include one or more of a page archived, page commented, page copied, page deleted, page edited, page labeled, page moved, page owner changed, page published, page status changed, attachment added to page, attachment deleted from page, attachment deleted from page, manual trigger from page, task created, task status changed, blog commented, blog labeled, blog published, attachment added to blog, attachment deleted from blog, user mentioned, space archived, space created, or a combination of these. In some embodiments, these example triggers are intended for use with reference to the context of a documentation platform.

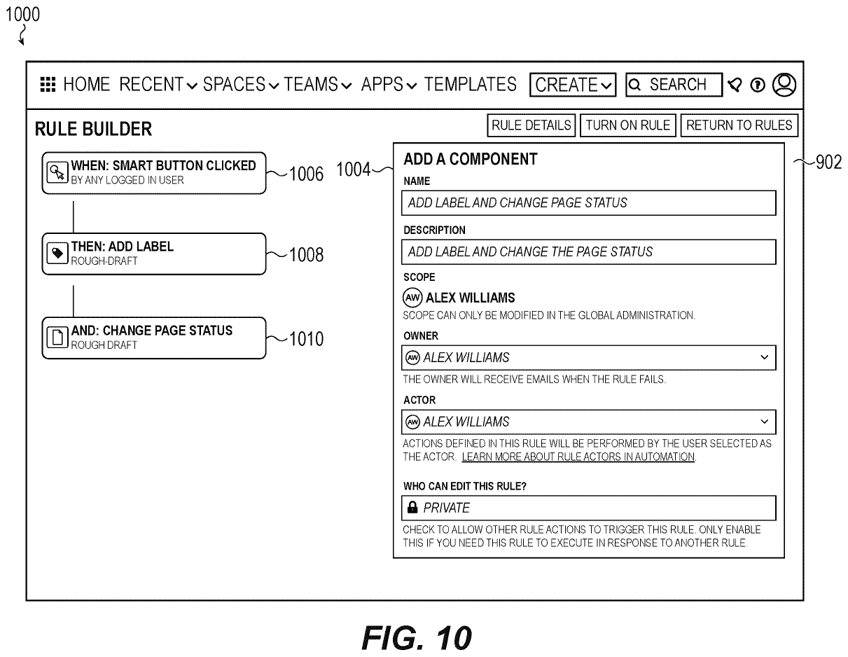

FIG. 10 shows an example frontend interface 1000 that supports user-defined button elements for collaboration platforms, in accordance with aspects described herein. Frontend interface 1000 may be an example of one or more of the frontend interfaces described herein following selection by a user of a user-defined button element trigger, for example smart button trigger 916. Following selection, the smart button trigger component 1006 may be shown as part of the automation rule flow.

For the smart button trigger component 1006, a component specification window 1004 may be displayed, for example when a user selects to include the smart button trigger component 1006 in the automation rule, or upon selection of the smart button trigger component 1006 during modification or editing of the automation rule flow. The component specification window 1004 includes a name field to define a name for the smart button, such as “ADD LABEL AND CHANGE PAGE STATUS” for a smart button associated with those actions. A description field may provide a description for the smart button. An owner field may be used to specify the owner of the automation rule, where the owner may receive a communication when the automation rule fails. An actor field may be used to specify the actor for the automation rule, where the actions performed by the automation rule in the collaboration system are performed by the user selected as the actor. In some examples, a field may be provided to define who can edit the automation rule. In some examples, the field may be used to allow other rule action (e.g., automation rule action components) to trigger the automation rule. For example, if marked “private” then the automation rule may be forbidden from being triggered by other automation rules. However, if marked “public” then the automation rule may be triggered by other automation rules.

In some examples, the automation rule triggered by the smart button trigger component 1006 may have a first action component 1008 and a second action component 1010. In some examples, the first action component 1008 may be an action component that adds a label to an electronic document from which the automation rule was triggered (e.g., a page or issue). In some examples, the second action component 1010 may be an action component that changes a status of an electronic document from which the automation rule was triggered (e.g., a page or issue)

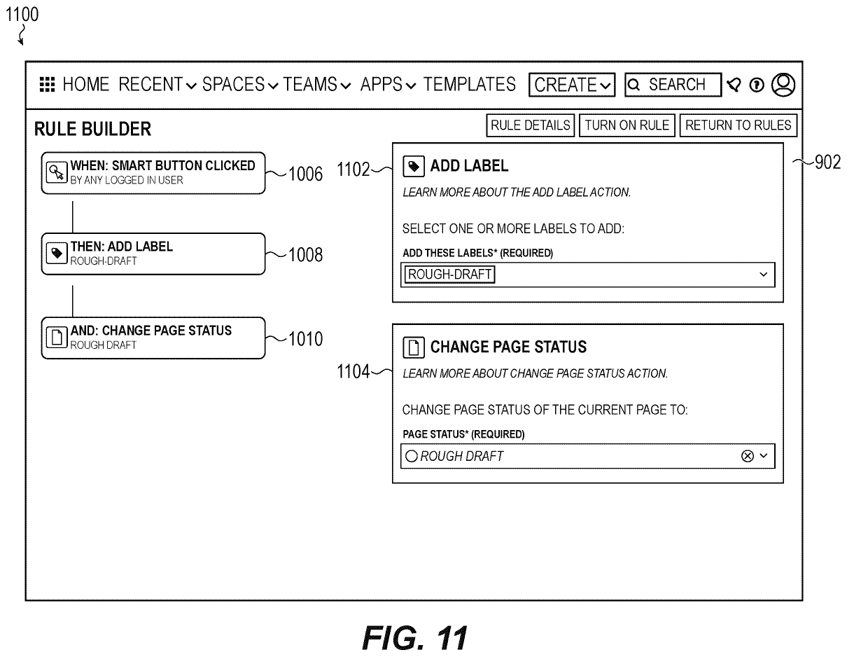

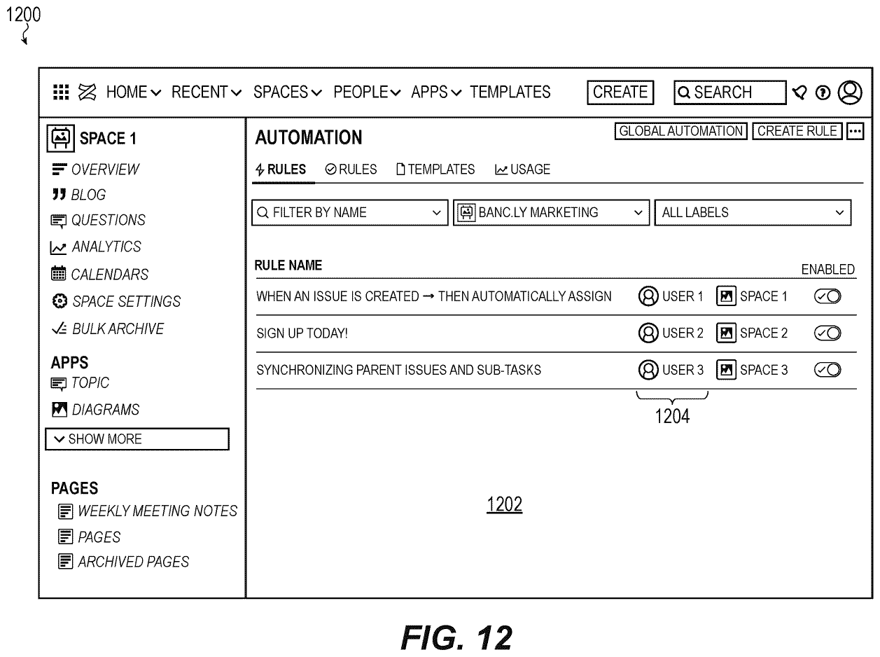

FIG. 11 shows an example frontend interface 1100 that supports user-defined button elements for collaboration platforms, in accordance with aspects described herein. Frontend interface 1100 may be an example of one or more of the frontend interfaces described herein following selection by a user of a user-defined button element trigger, for example smart button trigger 916. In particular, the frontend interface 1100 shows a first component specification window 1102 for the first action component 1008 and a second component specification window 1104 for the second action component 1010.

For the first action component 1008, the first component specification window 1102 may be displayed, for example upon selection by a user of the graphical element corresponding to the first action component 1008. The first component specification window 1102 may include fields for the specification or modification of one or more parameters for the action component. In the example depicted with reference to the frontend interface 1100, the first action component 1008 is an add label action component. The parameter for the first action component 1008 is a label of “rough draft,” where a corresponding indication of the label is added to the electronic document that triggered the automation rule in response to a user selection of the user-defined button element corresponding to the automation rule.

For the second action component 1010, the second component specification window 1104 may be displayed, for example upon selection by a user of the graphical element corresponding to the second action component 1010. The second component specification window 1104 may include fields for the specification or modification of one or more parameters for the action component. In the example depicted with reference to the frontend interface 1100, the second action component 1010 is a page status action component. The parameter for the second action component 1010 is a page status of “rough draft,” where a corresponding status indicator for the electronic document that triggered the automation rule in response to a user selection of the user-defined button element corresponding to the automation rule changes the status for the page to be a “rough draft.”

FIG. 12 shows an example frontend interface 1200 that supports user-defined button elements for collaboration platforms, in accordance with aspects described herein. Frontend interface 1200 may be an example of one or more of the frontend interfaces described herein following saving of one or more automation rules, for example for automation rule management.

In particular, the frontend interface 1200 shows an automation rule management interface 1202 that has a set of three automation rules. The users that own the three automation rules are indicated as User 1, User 2, and User 3, respectively. Each automation rule may also be associated with a space, and an indication of whether the automation rule is enabled. In some examples, the automation rule management interface 1202 depicted in the frontend interface 1200 may be accessible only to certain users, for example a user having administrative privileges with respect to a space or spaces. When a user-defined button element has been created as an automation rule, for example according to one or more of the techniques described herein, the automation rule (and thus the button) may be managed via the automation rule management interface 1202 depicted in the frontend interface 1200.

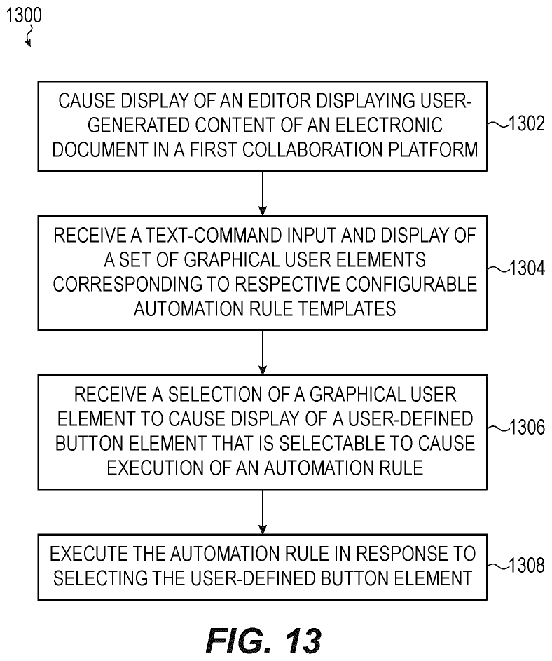

FIG. 13 shows an example method 1300, according to one or more aspects described herein. In one or more embodiments, method 1300 supports one or more aspects of smart buttons for automation rules in collaboration platforms, as further described herein. In some examples, method 1300 is a computer-implemented method for updating or generating content using dynamic automation rule buttons within a collaboration system. The method 1300 may be performed using one or more processors, memory, or other components or resource allocations of the collaboration system, including one or more collaboration platforms (e.g., a collaboration platform associated with first platform backend 108 and/or a collaboration platform associated with second platform backend 110), or the centralized automation rule service 112, including corresponding resources thereof.

At 1302, the method 1300 includes causing display of an editor displaying user-generated content of an electronic document in a first collaboration platform. In some embodiments, the method 1300 includes causing display of a frontend of a first collaboration platform of the collaboration system, the frontend including an editor displaying user-generated content of an electronic document hosted by the first collaboration platform, the user-generated content generated by an authenticated user of the first collaboration platform.

At 1304, the method 1300 includes receive a text-command input and cause display of a set of graphical user elements corresponding to respective configurable automation rule templates. In some embodiments, the method 1300 includes, in response to a text-command input provided to the editor at a particular location within the electronic document, causing display of a set of graphical user elements in the frontend of the first collaboration platform, each graphical user element of the set of graphical user elements corresponding to a respective configurable automation rule template of a set of configurable automation rule templates.

At 1306, the method 1300 includes receiving a selection of a graphical user element to cause display of a user-defined button element that is selectable to cause execution of an automation rule. In some embodiments, the method 1300 includes, subsequent to a user selection of one or more graphical user elements of the set of graphical user elements, causing display of a user-defined button element at the particular location within the user-generated content of the electronic document, the user-defined button element selectable to cause execution of an automation rule executing automation components corresponding to the one or more graphical user elements.

At 1308, the method 1300 includes executing the automation rule in response to selecting the user-defined button element. In some embodiments, the method 1300 includes, in response to a user selection of the user-defined button element, causing execution of the automation rule to perform an action of the automation rule with respect to an object of the collaboration system.

In one or more embodiments, the method further includes in response to a determination that the object is hosted by a second collaboration platform, obtaining a permission profile of a second user that selected the user-defined button element and verifying the permission profile with respect to the action to be performed on the object hosted by the second collaboration platform; and in response to verifying the permission profile of the second user, performing the action on the object at the second collaboration platform.

In one or more embodiments, the method further includes identifying a first user identifier associated with a first user that selected the user-defined button element where a second user identifier is associated with the automation rule or a second user that created the user-defined button element, and the action of the automation rule is performed on the object in accordance with a permission profile associated with the second user identifier.

In one or more embodiments, the method further includes in response to a user selection of the user-defined button element, providing, to a second collaboration platform hosting the object, a request for the action to be performed at the second collaboration platform, the action corresponding to an action component of the automation rule; in response to the request, receiving an authentication request from the second collaboration platform; and in response to the authentication request, providing credentials of a first user that selected the user-defined button element to the second collaboration platform. In some embodiments, the action to be performed includes generating an issue in an issue tracking platform, the second collaboration platform including the issue tracking platform. In some embodiments, the action to be performed includes generating an email in a communication platform, the second collaboration platform including the communication platform, and a recipient of the email being an owner of the electronic document.

In one or more embodiments, the method further includes in response to detecting a user interaction with the user-defined button element, causing display of an information window within the electronic document, the information window indicating the action of the automation rule to be performed in response to selecting the user-defined button element.

In one or more embodiments, the method further includes in response to the user selection of the user-defined button element, causing display, within the electronic document, of a status notification regarding the performance of the action of the automation rule.

In one or more embodiments, the method further includes in response to the user selection of the user-defined button element, providing an application programming interface (API) call to an automation rule service, the API call including an indication of the automation rule, information associated with the electronic document, and an identifier associated with the user selection of the user-defined button element, the automation rule executed in response to the API call.

In one or more embodiments, the method further includes providing a user identifier of the authenticated user at the first collaboration platform, session information for the authenticated user, and authentication information for the authenticated user, where the automation rule is executed at a second collaboration platform of the collaboration system using one or more of the user identifier, the session information, or the authentication information.

In some embodiments, the first collaboration platform includes a document management platform; the action of the automation rule includes generating an issue in an issue tracking platform or an email in a communication platform; and the automation rule is executed at a second collaboration platform of the collaboration system, the second collaboration platform including the issue tracking platform or the communication platform, respectively.

The method 1300 may be variously embodied, extended, or adapted, as described in the following paragraphs and elsewhere in this description.

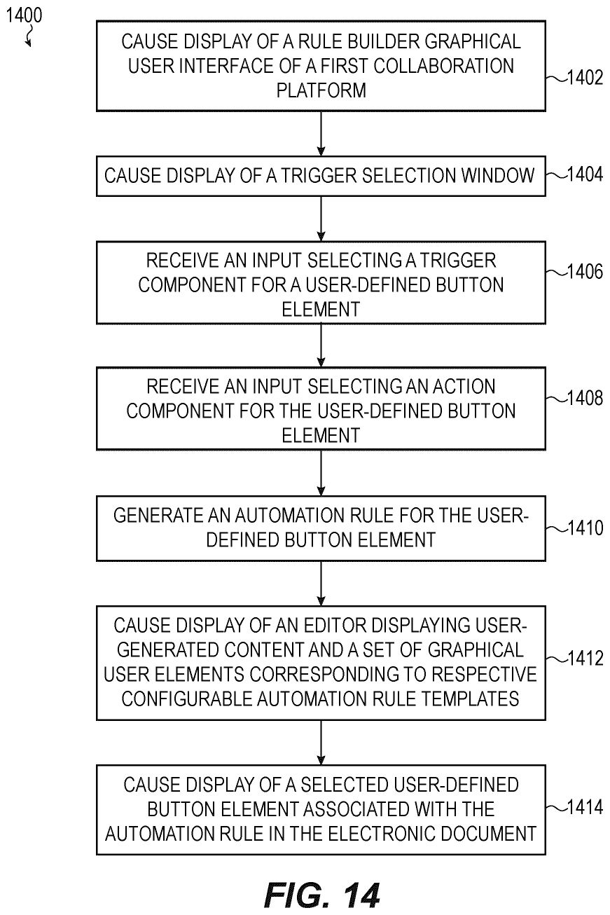

FIG. 14 shows an example method 1400, according to one or more aspects described herein. In one or more embodiments, method 1400 supports one or more aspects of smart buttons for automation rules in collaboration platforms, as further described herein. In some examples, method 1400 is a computer-implemented method for updating or generating content using automation rule buttons within a collaboration system. The method 1400 may be performed using one or more processors, memory, or other components or resource allocations of the collaboration system, including one or more collaboration platforms (e.g., a collaboration platform associated with first platform backend 108 and/or a collaboration platform associated with second platform backend 110), or the centralized automation rule service 112, including corresponding resources thereof.

At 1402, the method 1400 includes causing display of a rule builder graphical user interface of a first collaboration platform. In some embodiments, the method 1400 includes causing display of a rule builder graphical user interface of a first collaboration platform of the collaboration system, the rule builder graphical user interface including a rule component selection user element.

At 1404, the method 1400 includes causing display of a trigger selection window. In some embodiments, the method 1400 includes, in response to receiving a selection of the rule component selection user element, causing display of a trigger selection window for a set of candidate trigger components for an automation rule, the set of candidate trigger components including a trigger component for a user-defined button element.

At 1406, the method 1400 includes receiving an input selecting a trigger component for a user-defined button element. In some embodiments, the method 1400 includes, in response to receiving a first input of the rule builder graphical user interface selecting the trigger component for the user-defined button element, causing display of a first one or more graphical elements representing the trigger component in a proposed automation rule flow.

At 1408, the method 1400 includes receiving an input selecting an action component for the user-defined button element. In some embodiments, the method 1400 includes, in response to receiving a second input of the rule builder graphical user interface selecting an action component for the automation rule, causing display of a second one or more graphical elements representing the action component in the proposed automation rule flow.

At 1410, the method 1400 includes generating an automation rule for the user-defined button element. In some embodiments, the method 1400 includes causing generation of the automation rule using at least the trigger component for the user-defined button element and the action component.

At 1412, the method 1400 includes causing display of an editor displaying user-generated content and a set of graphical user elements corresponding to respective configurable automation rule templates. In some embodiments, the method 1400 includes subsequent to generating the automation rule, causing display of an editor and a set of graphical user elements in a frontend of the first collaboration platform, the editor displaying user-generated content of an electronic document generated by an authenticated user of the first collaboration platform, and each graphical user element of the set of graphical user elements corresponding to a respective configurable automation rule template of a set of configurable automation rule templates.

At 1414, the method 1400 includes causing display of a selected user-defined button element associated with an automation rule in the electronic document. In some embodiments, the method 1400 includes, in response to selecting a graphical user element of the set of graphical user elements, causing display of the user-defined button element at a particular location within the electronic document, the user-defined button element that is selectable to cause execution of the automation rule.

In one or more embodiments, the method further includes, in response to receiving a third input of the rule builder graphical user interface selecting the user-defined button element, displaying, in the frontend of the first collaboration platform, a trigger editing window for one or more parameters for the user-defined button element.

In one or more embodiments, the method further includes, in response to a third user input to the electronic document, causing display of a set of suggested user-defined button elements for the electronic document based at least in part on one or more parameters of the electronic document. In one or more embodiments, the method further includes generating the set of suggested user-defined button elements for the electronic document based at least in part on one or more of a space type associated with the electronic document, a user identifier for the electronic document, or a frequency of use of one or more user-defined button elements.

In some embodiments, the automation rule has a corresponding automation rule identifier, and the user-defined button element includes a link to the automation rule identifier. In one or more embodiments, the method further includes in response to one or more additional selections of the graphical user element, causing display of one or more additional instances of the user-defined button element in the electronic document, each instance of the one or more additional instances including the link to the automation rule identifier.

Embodiments contemplated herein include one or more non-transitory computer-readable media storing instructions to cause an electronic device, upon execution of the instructions by one or more processors (e.g., processing unit 2202) of the electronic device (e.g., electronic device 2200), to perform one or more elements of the method 1300 or 1400. Embodiments contemplated herein include an apparatus having logic, modules, or circuitry to perform one or more elements of the method 1300 or 1400. Embodiments contemplated herein include an apparatus having one or more processors (e.g., processing unit 2202) and one or more computer-readable media (e.g., memory 2204), using or storing instructions that, when executed by the one or more processors, cause the one or more processors to perform one or more elements of the method 1300 or 1400. Embodiments contemplated herein include a signal as described in or related to one or more elements of the method 1300 or 1400. Embodiments contemplated herein include a computer program or computer program product (e.g., memory 2204) having instructions, wherein execution of the program by a processor (e.g., processing unit 2202) causes the processor to carry out one or more elements of the method 1300 or 1400.

In some automation systems, content items must be in existences in order for those items to be subject to an automation rule. As such, it may be beneficial to provide dynamic references for the automation rules, such as the ability for an automation rule to operate on an electronic document generated as part of an automation rule, or a component thereof. Such electronic documents may be in-process electronic documents, and a reference or indicator of these documents may be an in-process identifier or dynamic reference. As further discussed herein, for an automation rule, an operation of an automation rule may use an in-process identifier for an in-process electronic document associated with a first action component for a second action component. For example, electronic documents or other content collaboration items generated by an automation rule may be inputs (dynamic values or dynamic references) within the same automation rule, providing complicated structures such as parent and child document tree structures, sub-tasks and sub-issue, and so on.

FIG. 15 shows an example frontend interface 1500 that supports references for automation rules in collaboration platforms, in accordance with aspects described herein. Frontend interface 1500 may include may also be referred to as a UI or GUI. In one or more embodiments, frontend interface 1500 may be displayed at a same display or interface one or more of the fronted interfaces described herein, including 800, for example rendered in response to a user selecting the rule builder button 802. The frontend interface 1500 displays the rule builder 1502, which includes graphical elements to assist a user in generating an automation rule to operate in a collaboration system (e.g., system 100), as further described herein. In some embodiments, rule builder 1502 may be at least a part of a GUI that is rendered by one of first platform backend 108 or second platform backend 110.

In one or more embodiments, rule builder 1502 may include a proposed automation flow (or workflow) region 1504 and a control region 1506.

Generally, the proposed automation flow region 1504 includes graphical elements representing automation rule components. In some examples, the graphical elements representing automation rule components may be replaced during rule building with graphical elements representing selected automation rule components. For example, the proposed automation flow region 1504 may include a trigger adding button that may be replaced by a graphical element representing a trigger component 1522 that is selected. The trigger adding button may also generally be a component adding button. The trigger component 1522 may be used to designate a trigger criteria with respect to an object hosted by the collaboration platform, the object including content of the collaboration platform.

The trigger component 1522 may be selected to cause display of a trigger selection window that includes a set of candidate trigger components for the automation rule to be generated. For example, the trigger component 1522 may be selected from the displayed set of trigger components 908 of the frontend interface 900.

A first action component 1524 may be displayed in the proposed automation flow region 1504 as a result of receiving, at the frontend interface 1500, a second user input of the rule builder graphical user interface. As further described herein, the first action component 1524 of the automation rule may be configured to generate an in-process electronic document. The in-process electronic document may be any electronic document of a collaboration platform, which may include a page, issue, task, post, board, and so on. In some examples, the in-process electronic document is a page of a documentation platform. The in-process electronic document may be associated with a document space of existing documents or a parent electronic document of the in-process electronic document.

After the second user input, a second action component 1526 may be displayed in the proposed automation flow region 1504 as a result of receiving, at the frontend interface 1500, a third user input of the rule builder graphical user interface. The third user input may also cause display of an action component editing window for the second action component, for example the editing window 1530. As further described herein, the second action component 1526 of the automation rule may be configured to use the in-process electronic document from the first action component 1524.

The editing window 1530 may include a first input field 1532 and a second input field 1534. In some examples, the first input field 1532 may be labeled as a dynamic rule reference, which may be another name for an identifier of an in-process electronic document. The first input field 1532 may be configured to receive an indication of an in-process identifier for the in-process electronic document (e.g., of the first action component 1524). The second input field 1534 may be configured to receive the selection of zero or more parameter values for the second action component 1536.

The editing window 1530 may be displayed in connection with the selection and/or display of the second action component 1526. That is, in some examples, the editing window 1530 may be displayed, and upon configuration may result in the display of a graphical element representing the second action component 1526. In other examples, the graphical element representing the second action component 1526 may be displayed, and automatically or upon selection the editing window 1530 may be displayed to accept user input for the configuration and specification of the second action component 1526 as part of the automation rule.

Following selection and configuration of the trigger component 1522, the first action component 1524, and the second action component 1526, the automation may be saved. Saving the automation rule may include generating a service on the collaboration system that performs an operation on an object in response to an event satisfying a criteria of the trigger component 1522. The operation of the generated service includes an action of the first action component and an action of the second action component. The operation utilizes, for the second action component, the in-process identifier for the in-process electronic document of the first action component.

As used herein, an input or input field may generally be populated via a text entry, or be populated via a drop-down selection. In some cases, text may be suggested (e.g., auto-populated) as a user types. The suggestion may be context-specific. For example, the suggested text may be different for the dynamic rule reference than for the parameter values. Similarly, the suggested text may be component-type specific, for example a label action may have different fields than a page creation action.

In one or more embodiments, the object that triggered the trigger component 1522 may be of a first collaboration platform (e.g., the first platform backend 108), and the object(s) referenced by the first action component 1524 and/or second action component 1526 may be of a second collaboration platform (e.g., the second platform backend 110). For example, a trigger may be satisfied by a change of status of a ticket in an issue tracking system, and a document within a documentation platform may be created as an in-process electronic document in response, according to the first action component 1524. The second action component 1526 may then refer to the in-process electronic document (e.g., using an in-process identifier) generated by the first action component 1524 to perform a second action, according to the second action component 1526.

In another example, a non-platform object may trigger the automation rule according to the trigger component 1522, and the object of the first action component 1524 and/or second action component 1526 may be of one of the platforms (e.g., the first platform backend 108 or the second platform backend 110). Alternatively, in other embodiments, the object that triggered the automation rule may be of one of the platforms, while the object of the label action component may be a non-platform object.

In some embodiments, user permissions may be evaluated when the automation rule is run, including when the automation rule operates across platforms, or between one of the platforms and a non-platform system. That is, as part of running an automation rule that starts, is initiated, or otherwise triggered in a first platform, one or more conditions or actions (including an action that uses an in-process identifier to refer to an in-process electronic document) may use a second platform as described herein. In such cases, the process of performing the automation may further include verifying or checking the credentials (permissions) of a user with the second platform. In other embodiments, access may be granted or denied based on a user role. Where an automation rule has been created (e.g., established as a service), if the user does not have sufficient permissions to access an object of the second platform, then the automation rule may cease to run or fail. In one or more embodiments, an error message or other indicator may be provided to the user or logged to indicate the failure to run the automation rule by reason of a lack of permissions. In some embodiments, where one or more components of the automation rule require checking permissions to access an object of a platform (e.g., the second platform or a non-platform system referenced by the automation rule), a GUI may be displayed to a user for the user to enter the user's credentials associated with that platform. The entered credentials may then be provided to the platform to allow the automation rule to continue to run.

FIG. 16 shows an example frontend interface 1600 that supports dynamic references for automation rules in collaboration platforms, in accordance with aspects described herein. Frontend interface 1600 may be an example of a frontend interface 900, described herein. For example the trigger adding button 1610, the component adding button 1612, the search box 1604, the set of tabs 1606, and the set of trigger components 1608 may be examples of the trigger adding button 910, the component adding button 912, the search box 904, the set of tabs 906, and the set of trigger components 908, respectively.

In a particular example, a trigger component may be a page published trigger 1620. The page published trigger 1620 may be for an object location in a first collaboration platform, such as a document management platform, and the first action component 1624 and/or the second action component 1626 may operate on an object of the first collaboration platform, or a second collaboration platform, such as a document management platform.

In another particular example, a trigger component may be a task trigger 1614, such as a task created trigger or a task status changed trigger. The task trigger 1614 may be for an object location in a first collaboration platform, such as an issue tracking platform, and the first action component 1624 and/or the second action component 1626 may operate on an object of the first collaboration platform, or a second collaboration platform, such as a document management platform.

Other triggers of the set of triggers may include an incoming webhook trigger 1622 that may be from a third-party application or system, for example outside of the collaboration system 100. In such case, the trigger may be based on an event outside of the collaboration system, while the first action component 1624 and/or the second action component 1626 may operate on an object of a collaboration platform within the collaboration system 100, such as the first collaboration platform or the second collaboration platform.

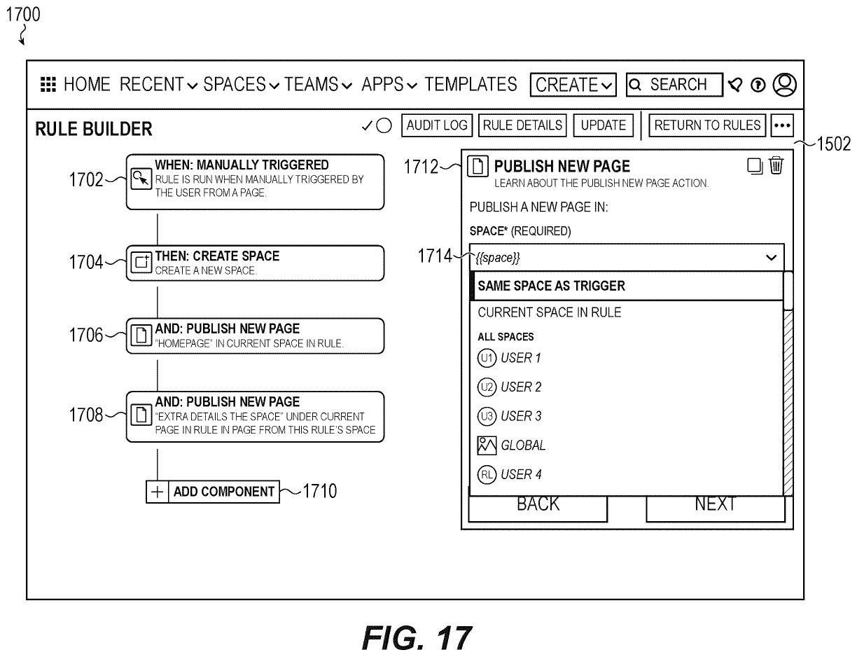

FIG. 17 shows an example frontend interface 1700 that supports dynamic references for automation rules in collaboration platforms, in accordance with aspects described herein. Frontend interface 1700 may be an example of a frontend interface described herein, including frontend interface 1600.

The example of the frontend interface 1700 includes a trigger component 1702, a first action component 1704, a second action component 1706, and a third action component 1708. The trigger component 1702 may include the trigger criteria being satisfied manually, for example by the selection of a graphical user element from a page in a document management platform. The first action component 1704 may be a create space action, where a new space is created responsive to the manual trigger. In some examples, the created space may be an example of an in-process electronic document.

The second action component 1706 may be a publish new page action. In the configuration of the second action component 1706, the dynamic rule reference may be input or otherwise set to be the space created by the create space action associated with the first action component. For example, the second action component 1706 may use a dynamic reference as an indication of the in-process electronic document. In the example of a reference to the generated new space, the reference (e.g., {{space}}) may be provided in an input field 1714 in an action editing window 1712 used to indicate that the automation rule is to perform the action (publishing a new page) within the previously-created space. As such, the automation rule, during execution may generate an in-process identifier for the in-process electronic document (the new space), and the second action component 1706 may uses this identifier when generating the new page in connection with the second action component 1706.

Similarly, the third action component 1708 may be a publish new page action. In the configuration of the third action component 1708, the dynamic rule reference may be input or otherwise set to generate a new page under (e.g., as a child of) a current page in the rule, within the same space. In such example, the third action component 1708 may use reference to the new page generated in connection with the second action component 1706, for example with a reference (e.g., {{parent}}, {{page}}) may be used to indicate that the automation rule is the perform the action (publishing a new page) as a child from the previously-created page. As such, the automation rule, during execution may generate an in-process identifier for the in-process electronic document (the new page of the second action according to the second action component 1706), and the third action component 1708 may use this identifier of the parent page when generating the new, child page in connection with the third action component 1708.

One or more additional automation rule components may be further added using the add component button 1710.

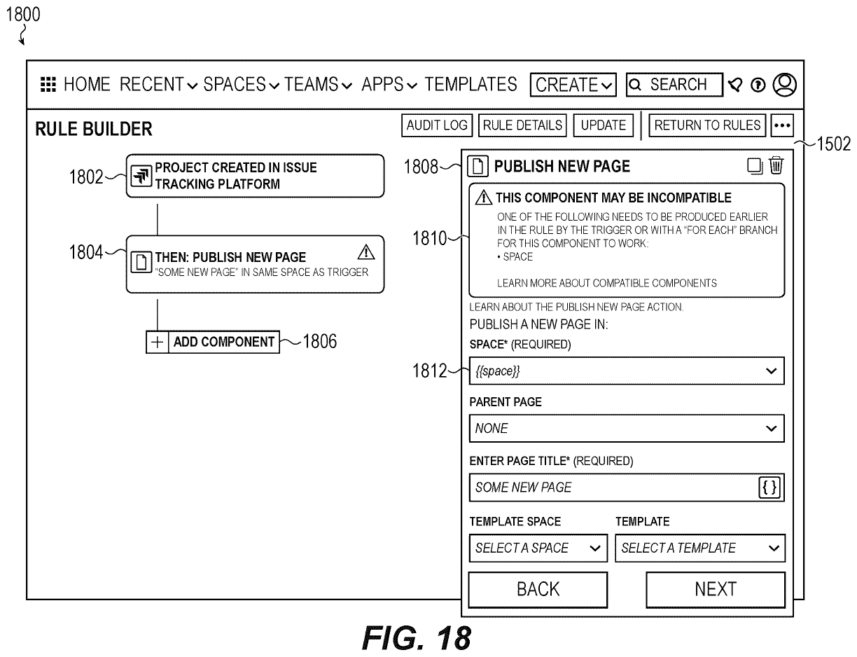

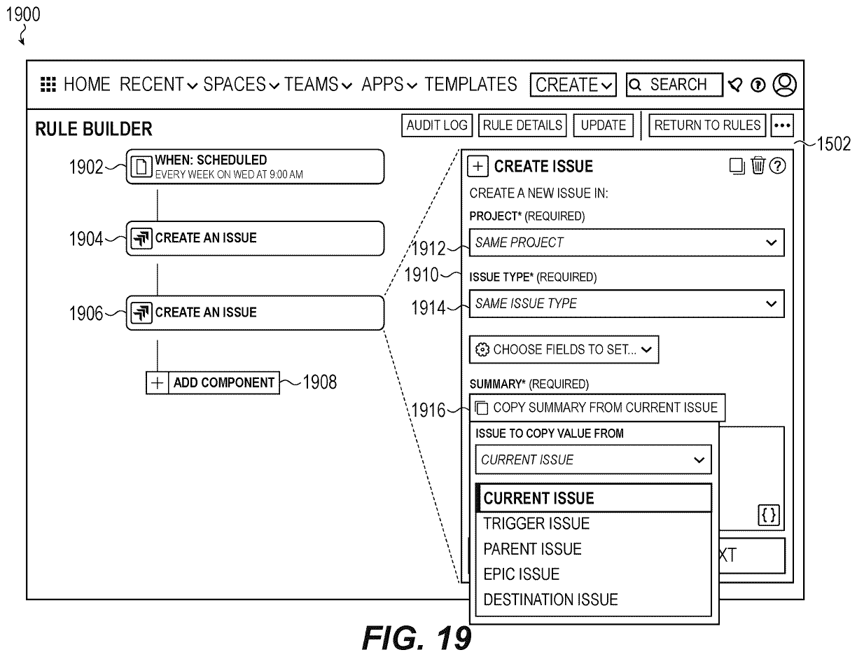

FIG. 18 shows an example frontend interface 1800 that supports dynamic references for automation rules in collaboration platforms, in accordance with aspects described herein. Frontend interface 1800 may be an example of a frontend interface described herein, including frontend interface 1600 or frontend interface 1700. In the example of the frontend interface 1800, a message 1810 with a warning and/or error may be provided in an action editing window 1808 when an in-process identifier does not refer to a valid in-process electronic document.

In the example of the frontend interface 1800, a cross-platform trigger may be used. That is, the trigger component 1802 may be the creation of a project in an issue tracking platform (a first collaboration platform). An action component 1804 may then be performed based on the triggering of the trigger component 1802. In some examples, the action component 1804 may be performed on an object in a different (second) collaboration platform, such as a document management platform. However, the publication of a new page according to the action component 1804 may require the new page to be within a space, which may not yet exist. As such, a correction would be to implement a new space component after the trigger component 1802 and before the action component 1804 to generate a new space (e.g., using the reference {{space}}), and then use an in-process identifier of the in-process electronic document (the new space) in the action component 1804 to refer to the new space. For example, the reference (e.g., {{space}}) may be provided in an input field 1812 to indicate that the automation rule is to perform the action (publishing a new page) within the previously-created space.

FIG. 19 shows an example frontend interface 1900 that supports dynamic references for automation rules in collaboration platforms, in accordance with aspects described herein. Frontend interface 1900 may be an example of a frontend interface described herein, including frontend interface 1600, frontend interface 1700, or frontend interface 1800. In the example of the frontend interface 1900, an in-process identifier may be used to refer to issues in an issue tracking system (the in-process electronic document) during performance of the automation rule.

In the example of the frontend interface 1900, a scheduled trigger may be used, which may be within the issue tracking platform. That is, the trigger component 1902 may be the occurrence of a certain time in the issue tracking platform.

A first action component 1904 that creates a new issue within the issue tracking platform may be specified. The electronic document (e.g., issue) within the issue tracking platform may be an in-process electronic document that is associated with an in-process identifier.

A second action component 1906 that creates a new issue within the issue tracking platform may be specified using an editing window 1910. During operation of the automation rule that includes the trigger component 1902, the first action component 1904, and the second action component 1906, the in-process electronic document (the issue) may be created in the first action and referred to by the second action component using the in-process identifier. A reference may be provided in an input field 1912 to indicate that the automation rule is to perform the action of the second action component 1906 (creating an issue) with a project that is based on the same project as the issue created with reference to the first action component 1904. As depicted for the editing window 1910, a project may be specified for the second action component 1906 (e.g., which may be the same for issues of both the first action component 1904 and the second action component 1906). A reference may be provided in an input field 1914 to indicate that the automation rule is to perform the action of the second action component 1906 with an issue type that is the same issue type as the issue created with reference to the first action component 1904. A reference may be provided in an input field 1916 to indicate that a summary for the issue generated in connection with the second action component 1906 may be based on a current issue, a trigger issue, a parent issue, an epic issue, or a destination issue, where the creation of the summary in the issue generated in response to the second action component may use the in-process identifier to refer to the issue generated in response to the first action component 1904. In some examples, the same issue type and/or same project as a parent issue may be used.

In one or more examples described herein, the in-process electronic document may be modified, revised, or otherwise updated using content generated by other components of the automation rule (e.g., by one or more action components). This content may be a different in-process electronic document or derived from another in-process document. For example, an in-process electronic document may be a page that is generated, and the content of the page may be updated by another automation rule component to include a summary of another content item, such as an issue or document that was created by a component of the automation rule.

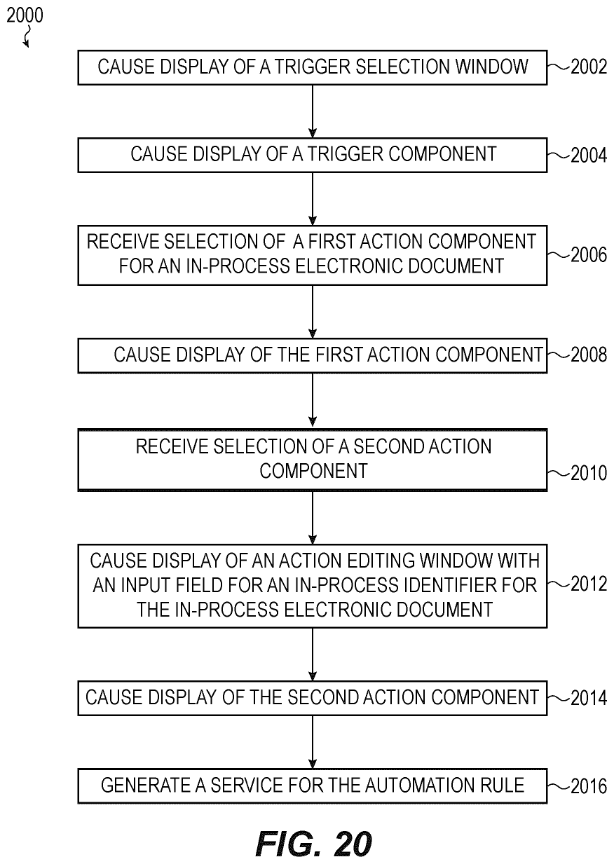

FIG. 20 shows an example method 2000, according to one or more aspects described herein. In one or more embodiments, method 2000 supports one or more aspects of dynamic references for automation rules in collaboration platforms, as further described herein. In some examples, method 2000 is a computer-implemented method for performing user updates in response to user identity events within a collaboration system. The method 2000 may be performed using one or more processors, memory, or other components or resource allocations of the collaboration system, including one or more collaboration platforms (e.g., a collaboration platform associated with first platform backend 108 and/or a collaboration platform associated with second platform backend 110), or the centralized automation rule service 112, including corresponding resources thereof.

At 2002, the method 2000 includes causing display of a trigger selection window. In some embodiments, the method 2000 includes causing display of a rule builder graphical user interface of a documentation platform of the collaboration system, the rule builder graphical user interface including a trigger selection window for a set of candidate trigger components for an automation rule.

At 2004, the method 2000 includes causing display of a trigger component. In some embodiments, the method 2000 includes in response to receiving a first user input of the rule builder graphical user interface selecting a trigger component for the automation rule, causing display of a first graphical element representing the trigger component in a proposed automation rule flow.

At 2006, the method 2000 includes receiving selection of a first action component for an in-process electronic document. In some embodiments, the method 1300 includes receiving a second user input of the rule builder graphical user interface selecting a first action component for the automation rule, the first action component configured to generate an in-process electronic document of the documentation platform of the collaboration system, the in-process electronic document associated with a document space of existing documents or a parent electronic document of the in-process electronic document.

At 2008, the method 2000 includes causing display of the first action component. In some embodiments, the method 2000 includes subsequent to the selection of the first action component, causing display of a second graphical element representing the first action component in the proposed automation rule flow.

At 2010, the method 2000 includes receiving a selection of a second action component. In some embodiments, the method 2000 includes receiving a third user input of the rule builder graphical user interface selecting a second action component for the automation rule.

At 2012, the method 2000 includes causing display of an action component editing window with an input field for an in-process identifier for the in-process electronic document. In some embodiments, the method 2000 includes in response to receiving the third user input, causing display of an action component editing window for the second action component, the action component editing window comprising a first input field configured to receive a first indication of an in-process identifier for the in-process electronic document of the first action component.

At 2014, the method 2000 includes causing display of the second action component. In some embodiments, the method 2000 includes subsequent to receiving the first indication of the in-process identifier, causing display of a third graphical element representing the second action component in the proposed automation rule flow.

At 2016, the method 2000 includes generating a service for the automation rule. In some embodiments, the method 2000 includes generating a service on the collaboration system that performs an operation on an object in response to an event satisfying a criteria of the trigger component of the automation rule, wherein the operation corresponds to the first action component and the second action component, the operation utilizing, for the second action component, the in-process identifier for the in-process electronic document of the first action component.

In one or more embodiments, the method further includes in response to receiving a fourth user input of the rule builder graphical user interface selecting a third action component for the automation rule, causing display of a second action component editing window for the third action component; in response to determining that the third action component is incompatible with the trigger component, causing display, in the rule builder graphical user interface, of a notification of the incompatibility; and unselecting the third action component, where the second action component for the automation rule is selected based at least in part on being compatible with the trigger component.

In one or more embodiments, the method further includes generating, for the documentation platform, an automation rule template corresponding to the automation rule; and causing display, in a draft editing window for the documentation platform, of a set of graphical user elements, each graphical user element of the set of graphical user elements corresponding to a respective automation rule template of a set of automation rule templates, including the generated automation rule template.

In one or more embodiments, the method further includes subsequent to generating the service and in response to the event satisfying the criteria, identifying that the object of the collaboration system is of a second collaboration platform of the collaboration system; verifying a permission of a user of the documentation platform for an action corresponding to the second action component at the second collaboration platform; and in response to verifying the permission of the user, performing the operation at the second collaboration platform.

In some embodiments, the in-process identifier for the in-process electronic document is an identifier that uniquely identifies the in-process electronic document within the documentation platform. In some embodiments, the action component editing window further includes a second input field configured to receive a second indication that an owner for content associated with the object are to be a same owner as an initiator of the operation in response to the event. In some embodiments, the first action component editing window is configured to display a set of input fields based at least in part on the first user input selecting the trigger component. In some embodiments, the first indication of the in-process identifier for the in-process electronic document of the first action component includes a reference to a value output by the trigger component during the operation of the automation rule in response to the event.

The method 2000 may be variously embodied, extended, or adapted, as described in the following paragraphs and elsewhere in this description.

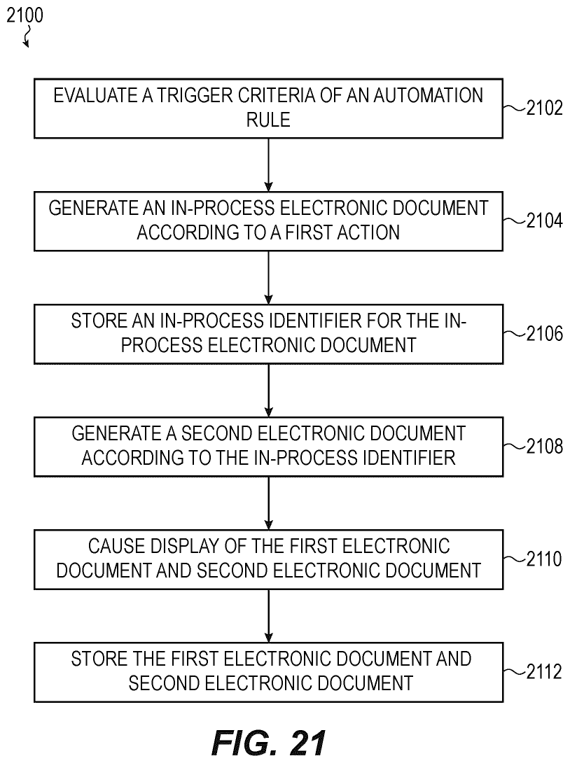

FIG. 21 shows an example method 2100, according to one or more aspects described herein. In one or more embodiments, method 2000 supports one or more aspects of dynamic references for automation rules in collaboration platforms, as further described herein. In some examples, method 2000 is a computer-implemented method for performing user updates in response to user identity events within a collaboration system. The method 2000 may be performed using one or more processors, memory, or other components or resource allocations of the collaboration system, including one or more collaboration platforms (e.g., a collaboration platform associated with first platform backend 108 and/or a collaboration platform associated with second platform backend 110), or the centralized automation rule service 112, including corresponding resources thereof.

At 2102, the method 2100 includes evaluating a trigger criteria of an automation rule. In some embodiments, the method 2100 includes in response to a user input to the collaboration system, evaluating a criteria of a trigger component of an automation rule to determine that the criteria is satisfied.

At 2104, the method 2100 includes generating an in-process electronic document according to a first action. In some embodiments, the method 2100 includes in response to determining that the trigger component is satisfied, generating, according to a first action component of the automation rule, an in-process electronic document of a documentation platform of the collaboration system, the in-process electronic document associated with a document space of existing documents or a parent electronic document of the in-process electronic document.

At 2106, the method 2100 includes storing an in-process identifier for the in-process electronic document. In some embodiments, the method 2100 includes storing an in-process identifier for the in-process electronic document of the first action component.

At 2108, the method 2100 includes generating a second electronic document according to the in-process identifier. In some embodiments, the method 2100 includes subsequent to the generation of the in-process electronic document, generating, using the stored in-process identifier for the in-process electronic document and according to a second action component of the automation rule, a second electronic document of the documentation platform, the second electronic document associated with the first electronic document.

At 2110, the method 2100 includes causing display of the first electronic document and second electronic document. In some embodiments, the method 2100 includes causing display, in a frontend of the documentation platform, a first graphical user element associated with the first electronic document and a second graphical user element associated with the second electronic document.

At 2112, the method 2100 includes storing the first electronic document and second electronic document. In some embodiments, the method 2100 includes storing the first electronic document and the second electronic document associated with a content object.

In some embodiments, the user input is to a second collaboration platform of the collaboration system, the documentation platform being a first collaboration platform of the collaboration system. In some embodiments, the second collaboration platform is an issue tracking platform and the criteria of the trigger component is an issue creation or a project creation.

In some embodiments, the content object is associated with a document space, the stored in-process identifier is of the document space, and the second action component is associated with generating a page within a same document space as the trigger component, the same document space being the document space associated with the content object.

In some embodiments, the content object is associated with the in-process electronic document, the stored in-process identifier is of the in-process electronic document, and the second action component is associated with generating a page depending on a current page, the current page being the in-process electronic document associated with the content object.

In some embodiments, the criteria of the trigger component includes a request to copy or move a page of the documentation platform.

In one or more embodiments, the method further includes identifying a user that provided the user input to the documentation platform that triggered the automation rule, and storing a user identifier for the user, where the second electronic document is generated using at least the user identifier and the in-process identifier for the in-process electronic document.

In one or more embodiments, the method further includes subsequent to storing the in-process electronic document or collaboration content item and in response to an event satisfying the criteria, identifying that the second electronic document or collaboration content item is hosted by a second collaboration platform, identifying a first user associated with the automation rule, obtaining a permission profile of a second user associated with the second electronic document or collaboration content item hosted by the second collaboration platform, and verifying the permission profile with respect to the operation to be performed on the second electronic document or collaboration content item.

In some embodiments, the criteria of the trigger component is an issue creation or a project creation of an issue tracking platform, the in-process electronic document is a document space or a primary document of the documentation platform, and the second electronic document is a secondary document.

In one or more embodiments, the method further includes the criteria of the trigger component is a document space creation or a page creation in the documentation platform, the in-process collaboration content item is an issue or a project of an issue tracking platform, and the second electronic document is a secondary document, issue, or project.

In some embodiments, the in-process identifier for the in-process collaboration content item is an identifier that uniquely identifies the in-process collaboration content item within the documentation platform. In some embodiments, the in-process electronic document is an in-process collaboration content item. In some embodiments, the second electronic document is a second collaboration content item.

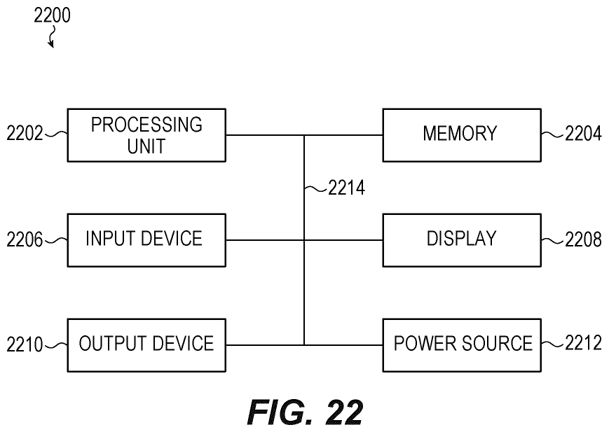

FIG. 22 shows a sample electrical block diagram of an electronic device 2200 that may perform the operations described herein. The electronic device 2200 may in some cases take the form of any of the electronic devices described with reference to FIGS. 1-21, including client devices, and/or servers or other computing devices associated with the system 100. The electronic device 2200 can include one or more of a processing unit 2202, a memory 2204 or storage device, input devices 2206, a display 2208, output devices 2210, and a power source 2212. In some cases, various implementations of the electronic device 2200 may lack some or all of these components and/or include additional or alternative components.

The processing unit 2202 can control some or all of the operations of the electronic device 2200. The processing unit 2202 can communicate, either directly or indirectly, with some or all of the components of the electronic device 2200. For example, a system bus or other communication mechanism 2214 can provide communication between the processing unit 2202, the power source 2212, the memory 2204, the input device(s) 2206, and the output device(s) 2210.

The processing unit 2202 can be implemented as any electronic device capable of processing, receiving, or transmitting data or instructions. For example, the processing unit 2202 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 2200 can be controlled by multiple processing units. For example, select components of the electronic device 2200 (e.g., an input device 2206) may be controlled by a first processing unit and other components of the electronic device 2200 (e.g., the display 2208) may be controlled by a second processing unit, where the first and second processing units may or may not be in communication with each other.

The power source 2212 can be implemented with any device capable of providing energy to the electronic device 2200. For example, the power source 2212 may be one or more batteries or rechargeable batteries. Additionally, or alternatively, the power source 2212 can be a power connector or power cord that connects the electronic device 2200 to another power source, such as a wall outlet.

The memory 2204 can store electronic data that can be used by the electronic device 2200. For example, the memory 2204 can store electronic data or content such as, for example, audio and video files, documents and applications, device settings and user preferences, timing signals, control signals, and data structures or databases. The memory 2204 can be configured as any type of memory. By way of example only, the memory 2204 can be implemented as random access memory, read-only memory, flash memory, removable memory, other types of storage elements, or combinations of such devices.

In some examples, the processing unit 2202 may be configured to, and/or the memory 2204 may store instructions that when executed by the processing unit 2202 cause the electronic device 2200 to, perform causing display of a frontend of a first collaboration platform of the collaboration system, the frontend including an editor displaying user-generated content of an electronic document hosted by the first collaboration platform, the electronic document generated by an authenticated user of the first collaboration platform; in response to a text-command input provided to the editor at a particular location within the electronic document, causing display of a set of graphical user elements in the frontend of the first collaboration platform, each graphical user element of the set of graphical user elements corresponding to a respective configurable automation rule template of a set of configurable automation rule templates; in response to a user selection of one of the set of graphical user elements, causing display of a user-defined button element at the particular location within the electronic document, the user-defined button element that is selectable to cause execution of an automation rule; and in response to selecting the displayed user-defined button element, executing the automation rule to perform an action of the automation rule on an object of the collaboration system.

In other examples, the processing unit 2202 may be configured to, and/or the memory 2204 may store instructions that when executed by the processing unit 2202 cause the electronic device 2200 to, perform causing display of a rule builder graphical user interface of a first collaboration platform of the collaboration system, the rule builder graphical user interface including a rule component selection user element; in response to receiving a selection of the rule component selection user element, displaying a trigger selection window for a set of candidate trigger components for an automation rule, the set of candidate trigger components including a trigger component for a user-defined button element; in response to receiving a first input of the rule builder graphical user interface selecting the trigger component for the user-defined button element, causing display of a first one or more graphical elements representing the trigger component in a proposed automation rule flow; in response to receiving a second input of the rule builder graphical user interface selecting an action component for the automation rule, causing display of a second one or more graphical elements representing the action component in the proposed automation rule flow; causing generation of the automation rule using at least the trigger component for the user-defined button element and the action component; subsequent to generating the automation rule, causing display of an editor and a set of graphical user elements in a frontend of the first collaboration platform, the editor displaying user-generated content of an electronic document generated by an authenticated user of the first collaboration platform, and each graphical user element of the set of graphical user elements corresponding to a respective configurable automation rule template of a set of configurable automation rule templates; and in response to selecting a graphical user element of the set of graphical user elements, causing display of the user-defined button element at a particular location within the electronic document, the user-defined button element that is selectable to cause execution of the automation rule.

In other examples, the processing unit 2202 may be configured to, and/or the memory 2204 may store instructions that when executed by the processing unit 2202 cause the electronic device 2200 to, perform causing display of a rule builder graphical user interface of a documentation platform of the collaboration system, the rule builder graphical user interface including a trigger selection window for a set of candidate trigger components for an automation rule; in response to receiving a first user input of the rule builder graphical user interface selecting a trigger component for the automation rule, causing display of a first graphical element representing the trigger component in a proposed automation rule flow; receiving a second user input of the rule builder graphical user interface selecting a first action component for the automation rule, the first action component configured to generate an in-process electronic document of the documentation platform of the collaboration system, the in-process electronic document associated with a document space of existing documents or a parent electronic document of the in-process electronic document; subsequent to the selection of the first action component, causing display of a second graphical element representing the first action component in the proposed automation rule flow; receiving a third user input of the rule builder graphical user interface selecting a second action component for the automation rule; in response to receiving the third user input, causing display of an action component editing window for the second action component, the action component editing window comprising a first input field configured to receive a first indication of an in-process identifier for the in-process electronic document of the first action component; subsequent to receiving the first indication of the in-process identifier, causing display of a third graphical element representing the second action component in the proposed automation rule flow; and generating a service on the collaboration system that performs an operation on an object in response to an event satisfying a criteria of the trigger component of the automation rule, wherein the operation corresponds to the first action component and the second action component, the operation utilizing, for the second action component, the in-process identifier for the in-process electronic document of the first action component.

In other examples, the processing unit 2202 may be configured to, and/or the memory 2204 may store instructions that when executed by the processing unit 2202 cause the electronic device 2200 to, perform, in response to a user input to the collaboration system, evaluating a criteria of a trigger component of an automation rule to determine that the criteria is satisfied; in response to determining that the trigger component is satisfied, generating, according to a first action component of the automation rule, an in-process electronic document of a documentation platform of the collaboration system, the in-process electronic document associated with a document space of existing documents or a parent electronic document of the in-process electronic document; storing an in-process identifier for the in-process electronic document of the first action component; subsequent to the generation of the in-process electronic document, generating, using the stored in-process identifier for the in-process electronic document and according to a second action component of the automation rule, a second electronic document of the documentation platform, the second electronic document associated with the first electronic document; causing display, in a frontend of the documentation platform, a first graphical user element associated with the first electronic document and a second graphical user element associated with the second electronic document; and storing the first electronic document and the second electronic document associated with a content object.

In various embodiments, the display 2208 provides a graphical output, for example associated with an operating system, user interface, and/or applications of the electronic device 2200 (e.g., a chat user interface, an issue-tracking user interface, an issue-discovery user interface, etc.). In one embodiment, the display 2208 includes one or more sensors and is configured as a touch-sensitive (e.g., single-touch, multi-touch) and/or force-sensitive display to receive inputs from a user. For example, the display 2208 may be integrated with a touch sensor (e.g., a capacitive touch sensor) and/or a force sensor to provide a touch-and/or force-sensitive display. The display 2208 is operably coupled to the processing unit 2202 of the electronic device 2200.

The display 2208 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 2208 is positioned beneath and viewable through a cover that forms at least a portion of an enclosure of the electronic device 2200.

In various embodiments, the input devices 2206 may include any suitable components for detecting inputs. Examples of input devices 2206 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 2206 may be configured to detect one or more types of input and provide a signal (e.g., an input signal) corresponding to the detected input. The signal may be provided, for example, to the processing unit 2202.

As discussed above, in some cases, the input device(s) 2206 include a touch sensor (e.g., a capacitive touch sensor) integrated with the display 2208 to provide a touch-sensitive display. Similarly, in some cases, the input device(s) 2206 include a force sensor (e.g., a capacitive force sensor) integrated with the display 2208 to provide a force-sensitive display.

The output devices 2210 may include any suitable components for providing outputs. Examples of output devices 2210 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device of the output devices 2210 may be configured to receive one or more signals (e.g., an output signal provided by the processing unit 2202) and provide an output corresponding to the signal.

In some cases, input devices 2206 and output devices 2210 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 2202 may be operably coupled to the input devices 2206 and the output devices 2210. The processing unit 2202 may be adapted to exchange signals with the input devices 2206 and the output devices 2210. For example, the processing unit 2202 may receive an input signal from an input device 2206 that corresponds to an input detected by the input device 2206. The processing unit 2202 may interpret the received input signal to determine whether to provide and/or change one or more outputs in response to the input signal. The processing unit 2202 may then send an output signal to one or more of the output devices 2210, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. The various functions and operations of a system, such as described herein, can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

1. A computer-implemented method for updating or generating content using dynamic automation rule buttons within a collaboration system, the computer-implemented method comprising:
causing display of a frontend of a first collaboration platform of the collaboration system, the frontend including an editor displaying user-generated content of an electronic document hosted by the first collaboration platform, the user-generated content generated by an authenticated user of the first collaboration platform;
in response to a text-command input provided to the editor at a particular location within the electronic document, causing display of a set of graphical user elements in the frontend of the first collaboration platform, each graphical user element of the set of graphical user elements corresponding to a respective configurable automation rule template of a set of configurable automation rule templates;
subsequent to a user selection of one or more graphical user elements of the set of graphical user elements, causing display of a user-defined button element at the particular location within the user-generated content of the electronic document, the user-defined button element selectable to cause execution of an automation rule executing automation components corresponding to the one or more graphical user elements; and
in response to a user selection of the user-defined button element, causing execution of the automation rule to perform an action of the automation rule with respect to an object of the collaboration system.

2. The computer-implemented method of claim 1, wherein performing the action of the automation rule comprises:
in response to a determination that the object is hosted by a second collaboration platform, obtaining a permission profile of a second user that selected the user-defined button element and verifying the permission profile with respect to the action to be performed on the object hosted by the second collaboration platform; and
in response to verifying the permission profile of the second user, performing the action on the object at the second collaboration platform.

3. The computer-implemented method of claim 1, wherein:
the computer-implemented method further comprises:
identifying a first user identifier associated with a first user that selected the user-defined button element;
a second user identifier is associated with the automation rule or a second user that created the user-defined button element; and
the action of the automation rule is performed on the object in accordance with a permission profile associated with the second user identifier.

4. The computer-implemented method of claim 1, further comprising:
in response to the user selection of the user-defined button element, providing, to a second collaboration platform hosting the object, a request for the action to be performed at the second collaboration platform, the action corresponding to an action component of the automation rule;
in response to the request, receiving an authentication request from the second collaboration platform; and
in response to the authentication request, providing credentials of a first user that selected the user-defined button element to the second collaboration platform.

5. The computer-implemented method of claim 4, wherein:
the action to be performed comprises generating an issue in an issue tracking platform, the second collaboration platform comprising the issue tracking platform.

6. The computer-implemented method of claim 4, wherein:
the action to be performed comprises generating an email in a communication platform, the second collaboration platform comprising the communication platform, and a recipient of the email being an owner of the electronic document.

7. The computer-implemented method of claim 1, further comprising:
in response to detecting a user interaction with the user-defined button element, causing display of an information window within the electronic document, the information window indicating the action of the automation rule to be performed in response to selecting the user-defined button element.

8. The computer-implemented method of claim 1, further comprising:
in response to the user selection of the user-defined button element, causing display, within the electronic document, of a status notification regarding the performance of the action of the automation rule.

9. The computer-implemented method of claim 1, further comprising:
in response to the user selection of the user-defined button element, providing an application programming interface (API) call to an automation rule service, the API call including an indication of the automation rule, information associated with the electronic document, and an identifier associated with the user selection of the user-defined button element, the automation rule executed in response to the API call.

10. A computer-implemented method for updating or generating content using dynamic automation rule buttons within a collaboration system, comprising:
causing display of a rule builder graphical user interface of a first collaboration platform of the collaboration system, the rule builder graphical user interface including a rule component selection user element;
in response to receiving a selection of the rule component selection user element, displaying a trigger selection window for a set of candidate trigger components for an automation rule, the set of candidate trigger components including a trigger component for a user-defined button element;
in response to receiving a first input of the rule builder graphical user interface selecting the trigger component for the user-defined button element, causing display of a first one or more graphical elements representing the trigger component in a proposed automation rule flow;
in response to receiving a second input of the rule builder graphical user interface selecting an action component for the automation rule:
causing display of a second one or more graphical elements representing the action component in the proposed automation rule flow; and
causing generation of the automation rule using at least the trigger component for the user-defined button element and the action component;
subsequent to generating the automation rule, causing display of an editor and a set of graphical user elements in a frontend of the first collaboration platform, the editor displaying user-generated content of an electronic document generated by an authenticated user of the first collaboration platform, and each graphical user element of the set of graphical user elements corresponding to a respective configurable automation rule template of a set of configurable automation rule templates; and
in response to selecting a graphical user element of the set of graphical user elements, causing display of the user-defined button element at a particular location within the electronic document, the user-defined button element selectable to cause execution of the automation rule.

11. The computer-implemented method of claim 10, further comprising:
in response to receiving a third input of the rule builder graphical user interface selecting the user-defined button element, displaying, in the frontend of the first collaboration platform, a trigger editing window for one or more parameters for the user-defined button element.

12. The computer-implemented method of claim 10, further comprising:
in response to a third user input to the electronic document, causing display of a set of suggested user-defined button elements for the electronic document based at least in part on one or more parameters of the electronic document.

13. The computer-implemented method of claim 12, further comprising:
generating the set of suggested user-defined button elements for the electronic document based at least in part on one or more of a space type associated with the electronic document, a user identifier for the electronic document, or a frequency of use of one or more user-defined button elements.

14. The computer-implemented method of claim 10, wherein:
the automation rule has a corresponding automation rule identifier; and
the user-defined button element includes a link to the automation rule identifier.

15. The computer-implemented method of claim 14, further comprising:
in response to one or more additional selections of the graphical user element, causing display of one or more additional instances of the user-defined button element in the electronic document, each instance of the one or more additional instances including the link to the automation rule identifier.

16. A collaboration system for updating content using dynamic automation rule buttons, the collaboration system comprising:
a first collaboration platform; and
a centralized automation rule service managing a set of automation rules, the collaboration system configured to:
cause display of a frontend of the first collaboration platform, the frontend including an editor displaying user-generated content of an electronic document hosted by the first collaboration platform, the user-generated content generated by an authenticated user of the first collaboration platform;
in response to a text-command input provided to the editor at a particular location within the electronic document, cause display, of a set of graphical user elements in the frontend of the first collaboration platform, each graphical user element of the set of graphical user elements corresponding to a respective configurable automation rule template of a set of configurable automation rule templates;
subsequent to a user selection of one or more graphical user elements of the set of graphical user elements, cause display of a user-defined button element at the particular location within the user-generated content of the electronic document, the user-defined button element selectable to cause execution of an automation rule executing automation components corresponding to the one or more graphical user elements; and
in response to a user selection of the user-defined button element, cause execution of the automation rule to perform an action of the automation rule with respect to an object of the collaboration system.

17. The collaboration system of claim 16, further comprising:
providing a user identifier of the authenticated user at the first collaboration platform, session information for the authenticated user, and authentication information for the authenticated user, wherein the automation rule is executed at a second collaboration platform of the collaboration system using one or more of the user identifier, the session information, or the authentication information.

18. The collaboration system of claim 16, wherein the collaboration system configured to perform the action of the automation rule comprises the collaboration system configured to:
in response to a determination that the object is hosted by a second collaboration platform, obtain a permission profile of a second user that selected the user-defined button element and verify the permission profile with respect to the action to be performed on the object hosted by the second collaboration platform; and
in response to verifying the permission profile of the second user, perform the action on the object at the second collaboration platform.

19. The collaboration system of claim 16, wherein:
the collaboration system is further configured to:
identify a first user identifier associated with a first user that selected the user-defined button element;
a second user identifier is associated with the automation rule or a second user that created the user-defined button element; and
the action of the automation rule is performed on the object in accordance with a permission profile associated with the second user identifier.

20. The collaboration system of claim 16, wherein:
the first collaboration platform comprises a document management platform;
the action of the automation rule comprises generating an issue in an issue tracking platform or an email in a communication platform; and
the automation rule is executed at a second collaboration platform of the collaboration system, the second collaboration platform comprising the issue tracking platform or the communication platform, respectively.
